(19) United States
(12) Patent Application Publication
(10) Pub. No.: US 2019/0292805 A1
(43) Pub. Date: Sep. 26, 2019

(54) INTELLIGENT UMBRELLA AND INTEGRATED AUDIO SUBSYSTEM AND RACK GEAR ASSEMBLY

(71) Applicant: SHADECRAFT, INC., Pasadena, CA (US)

(72) Inventor: ARMEN GHARABEGIAN, GLENDALE, CA (US)

(73) Assignee: SHADECRAFT, INC.

(21) Appl. No.: 16/363,483

(22) Filed: Mar. 25, 2019

Related U.S. Application Data
(60) Provisional application No. 62/648,369, filed on Mar. 26, 2018.

(51) Int. Cl. E04H 15/02; E04H 15/28; A45B 23/00; F16H 19/04; F16H 25/20; F16H 1/16; F16H 57/02; H02S 30/20; H02S 40/38; H02K 7/06; H02K 7/116; G01W 1/02; H04R 1/02

(52) U.S. Cl. CPC E04H 15/02; F21V 33/00; A45B 23/00; F16H 19/04; F16H 25/20; F16H 1/16; F16H 57/02; H02S 30/20; H02S 40/38; H02K 7/06; H02K 7/1166; G01W 1/02; H04R 1/028; A45B 2023/0012; A45B 2200/1009; E04H 15/28

(57) ABSTRACT

An umbrella arm expansion assembly, comprising one or more arm expansion gear housings, an actuator housing including a linear actuator; one or more rack gear assemblies; and one or more arm support assemblies. The one or more rack gear assemblies move in a vertical direction in response to vertical movement of the linear actuator.

### RELATED APPLICATIONS

This application claims priority to U.S. provisional patent application Ser. No. 62/648,369, filed Mar. 26, 2018, entitled “Shading Device Rack Gear Assembly,” the disclosure of which is hereby incorporated by reference.

### BACKGROUND

Parasols, umbrellas and shading systems have limited functionality. Existing designs for expanding the frame and/or arms or blades use old, outdated designs as well as old, outdated materials. In additional, the footprint of expansion assemblies is large and may cause safety issues with users or operators.

### BRIEF DESCRIPTION OF DRAWINGS

FIGS. 1A, 1B and 1C illustrate a modular umbrella shading system according to embodiments;

FIGS. 2A, 2B and 2C illustrate a cut-away drawing of mechanical assemblies in a modular umbrella system according to embodiments;

FIG. 3 illustrates a block diagram power subsystem of a parasol, umbrella or shading system according to embodiments;

FIG. 4A illustrates a base assembly including a base stand, a base lower housing and base housing according to embodiments;

FIG. 4B illustrates a rechargeable power source housing according to embodiments;

FIG. 5A illustrates a block diagram of an intelligence housing according to embodiments

FIG. 5B illustrates a perspective view of an intelligence housing with one side removed according to embodiments;

FIG. 5C illustrates a perspective view of an intelligence housing with covers attached according to embodiments;

FIG. 5D illustrates a wind sensor assembly according to embodiments;

FIG. 6A illustrates a top view of an arm expansion assembly according to embodiments;

FIG. 6B illustrates a side isometric view of an arm expansion assembly according to embodiments;

FIG. 6C illustrates a front view of an arm expansion assembly according to embodiments;

FIG. 6D illustrates a side isometric view with gearing assembly covers removed according to embodiments;

FIG. 7A illustrates a top view of an arm expansion assembly in an open or deployed position according to embodiments;

FIG. 7B illustrates a side isometric view of an arm expansion assembly in an open or deployed position according to embodiments;

FIG. 7C illustrates a front view of an arm expansion assembly in an open or deployed position according to embodiments; and

FIG. 7D illustrates a side isometric view with gearing assembly covers removed of an arm expansion assembly in an arm expansion assembly according to embodiments.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

Also as used herein, one or more parameters may be descriptive of a collection of signal samples, such as one or more electronic documents, and exist in the form of physical signals and/or physical states, such as memory states. For example, one or more parameters may include parameters, such as 1) how much an assembly (e.g., motor assembly) may move or be requested to move; 2) a time of day at which an image was captured, a latitude and longitude of an image capture device, such as a camera; 3) time and day of when a sensor reading (e.g., humidity, temperature, air quality, UV radiation) may be received and/or measurements or values of sensor readings; and/or 4) operating conditions of one or more motors or other components or assemblies in a balcony shading and power system. Claimed subject matter is intended to embrace meaningful, descriptive parameters in any format, so long as the one or more parameters comprise physical signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a balcony shading and power system processor, controller and/or computing device). In the context of this specification, therefore, a special purpose computer or a similar special purpose electronic computing device (e.g., a balcony shading and power system processor, controller and/or computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., a balcony shading and power system processor, controller and/or computing device or single board computers, and various other electronic and mechanical devices coupled thereto or installed thereon. Microcontrollers may include processors, microprocessors, and other electronic components. Controller may be a commercially available processor such as an Intel Pentium, Raspberry Pi, other Linux-based computers, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. In embodiments, a processor and/or controller may be connected to other devices also via power buses from either a rechargeable power source and/or a solar charging assembly. Usually, a processor or controller, may execute an operating system which may be, for example, a Windows-based operating system (Microsoft), a MAC OS System X operating system (Apple Computer), one of many Linux-based operating system distributions, a portable electronic device operating system (e.g., mobile phone operating systems), microcomputer operating systems, and/or a UNIX operating systems. Embodiments are not limited to any particular implementation and/or operating system.

The specification may refer to an umbrella, a robotic shading system, or a parasol. In embodiments, each of these devices may be intelligent and/or automated. In embodiments, an umbrella, robotic shading system or a parasol may provide shade and/or coverage to a user from weather elements such as sun, wind, rain, and/or hail in an outdoor environment or outdoor portions of a structure (whether building, office and/or sports complexes). In embodiments, an umbrella, a robotic shading system or a parasol may be an automated, intelligent and/or employ artificial intelligence and/or machine learning. The device and/or apparatus may also be referred to as a sun shade, outdoor shade furniture, sun screen, sun shelter, awning, sun cover, sun marquee, brolly and other similar names, which may all be utilized interchangeably in this application. In embodiments, a shading device may refer to an umbrella, a parasol, a robotic shading system, a voice-activated hub having one or more shading elements and/or one or more pieces of shading fabric supported by one or more arms and/or a frame, and/or a lighting system having one or more shading elements and/or one or more pieces of shading fabric supported by one or more arms and/or a frame.

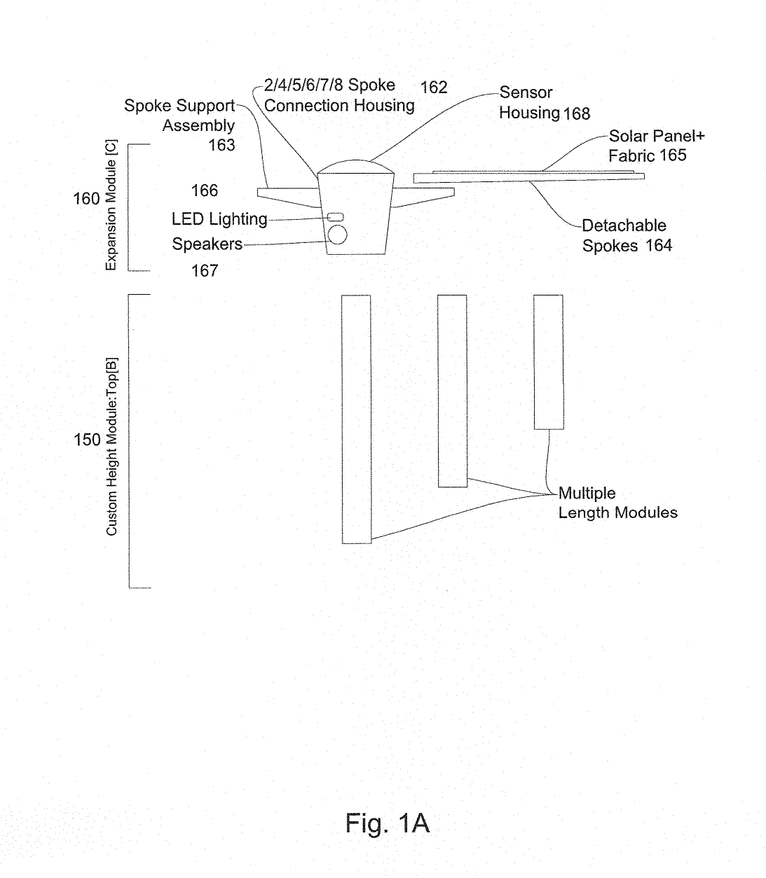

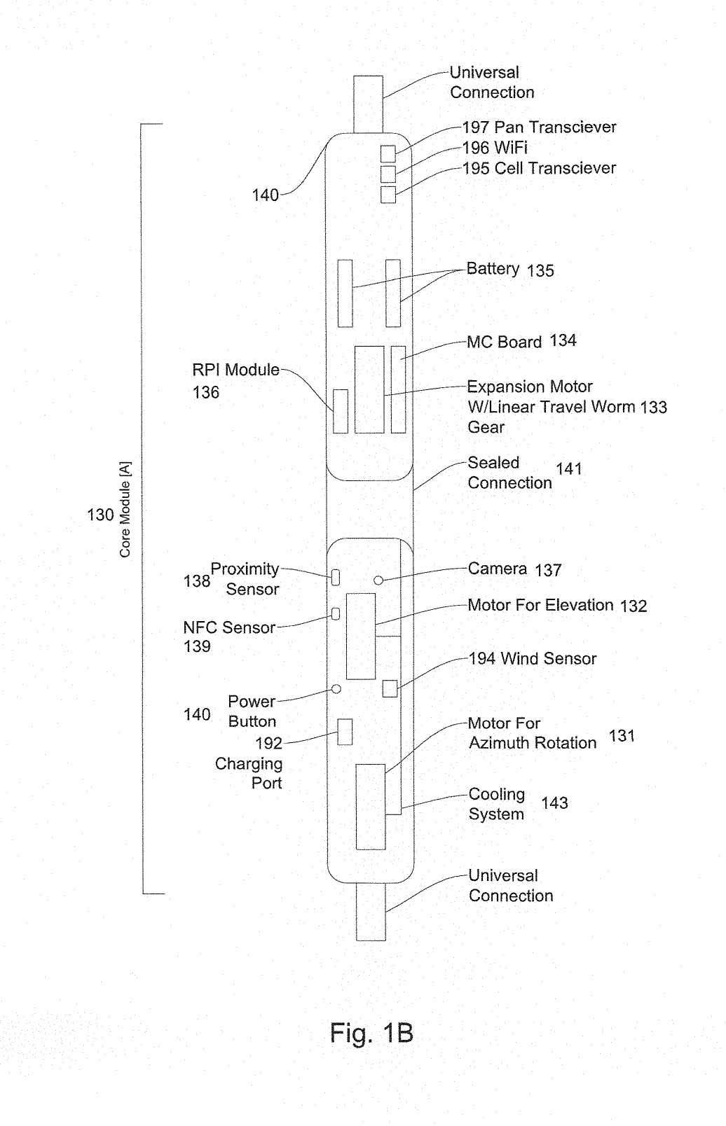

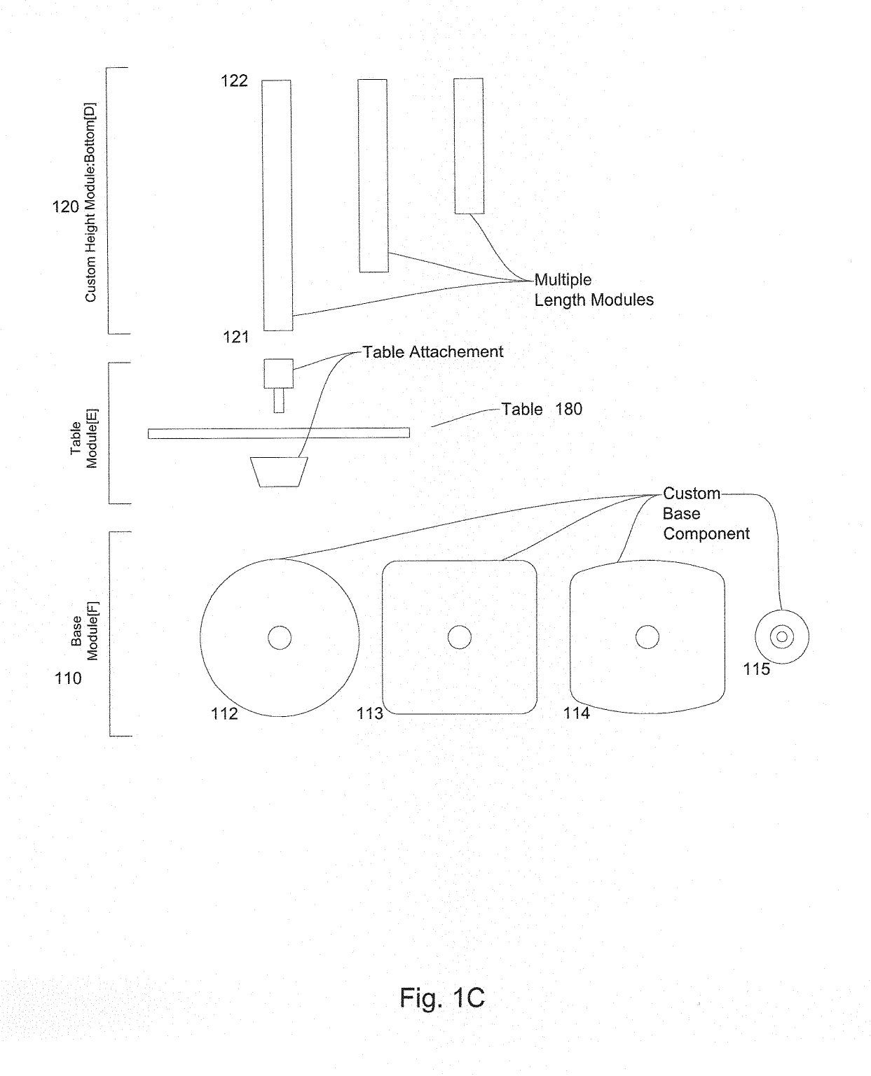

FIGS. 1A, 1B or 1C illustrates a modular umbrella or shading system according to embodiments. In embodiments, a modular umbrella system 100 comprises a base assembly or module 110, a first extension assembly or module 120, a core assembly module housing (or core umbrella assembly) 130, a second extension assembly or module 150, and an expansion sensor assembly or module (or an arm extension assembly or module) 160. In embodiments, a modular umbrella shading system 100 may not comprise a base assembly or module 110 and may comprise a table assembly or module 180 to connect to table tops, such as patio tables and/or other outdoor furniture. In embodiments, a table assembly or module 180 may comprise a table attachment and/or a table receptacle. In embodiments, a base module or assembly 110 may comprise a circular base component 112, a square or rectangular base component 113, a rounded edges base component 114, and/or a beach or sand base component 115. In embodiments, base components 112, 113, 114, and/or 115 may be interchangeable based upon a configuration required by an umbrella system and/or user. In embodiments, each of the different options for the base components 112, 113, 114, 115, and/or 180 may have a universal connector and/or receptacle to allow for easy interchangeability.

In embodiments, a first extension assembly or module 120 may comprise a shaft assembly having a first end 121 and a second end 122. In embodiments, a first end 121 may be detachably connectable and/or connected to a base assembly or module 110. In embodiments, a second end 122 may be detachably connected and/or connectable to a first end of a core umbrella assembly or module 130. In embodiments, a first end 121 and a second end 122 may have a universal umbrella connector. In other words, a connector may be universal within all modules and/or assemblies of a modular umbrella system to provide a benefit of allowing backwards capabilities with new versions of different modules and/or assemblies of a modular umbrella shading system. In embodiments, a first extension assembly or module 120 may have different lengths. In embodiments, different length first extension assemblies may allow a modular umbrella shading system to have different clearance heights between a base assembly or module 110 and/or a core umbrella assembly or module 130. In embodiments, a first extension assembly or module 110 may be a tube and/or a shell with channels, grooves and/or pathways for electrical wires and/or components and/or mechanical components. In embodiments, a first extension assembly 110 may be a shaft assembly having an inner core comprising channels, grooves and/or pathways for electrical wires, connectors and/or components and/or mechanical components.

In embodiments, a universal umbrella connector or connection assembly 124 may refer to a connection pair and/or connection assembly that may be uniform for all modules, components and/or assemblies of a modular umbrella system 100. In embodiments, having a universal umbrella connector or connection assembly 124 may allow interchangeability and/or backward compatibility of the various assemblies and/or modules of the modular umbrella system 100. In embodiments, for example, a diameter of all or most of universal connectors 124 utilized in a modular umbrella system may be the same. In embodiments, a universal connector or connection assembly 124 may be a twist-on connector. In embodiments, a universal connector 124 may be a drop in connector and/or a locking connector, having a male and female connector. In embodiments, a universal connector or connection assembly 124 may be a plug with another connector being a receptacle. In embodiments, universal connector 124 may be an interlocking plug receptacle combination. For example, universal connector 124 may be a plug and receptacle, jack and plug, flanges for connection, threaded plugs and threaded receptacles, snap fit connectors, adhesive or friction connectors. In embodiments, for example, universal connector or connection assembly 124 may be external connectors engaged with threaded internal connections, snap-fit connectors, push fit couplers. In embodiments, by having a universal connector or connection assembly 124 for joints or connections between a base module or assembly 110 and a first extension module or assembly 120, a first extension module or assembly 120 and a core assembly module or assembly 130, a core assembly module or assembly 130 and a second extension module or assembly 150, and/or a second extension module or assembly 150 and an expansion sensor module or assembly 160, an umbrella or shading object manufacturer may not need to provide additional parts for additional connectors for attaching, coupling or connecting different modules or assemblies of a modular umbrella shading system. In addition, modules and/or assemblies may be upgraded easily because one module and/or assembly may be switched out of a modular umbrella system without having to purchase or procure additional modules because of the interoperability and/or interchangeability.

In embodiments, a core umbrella assembly or module 130 may be positioned between a first extension assembly or module 120 and a second extension assembly or module 150. In embodiments, core umbrella assembly or module 130 may be positioned between a base assembly or module 110 and/or an expansion and sensor module or assembly 160. In embodiments, a core umbrella assembly or module 130 may comprise an upper core assembly 140, a core assembly connector or mid-section 141 and/or a lower core assembly 142. In embodiments, a core assembly connector 141 may be a sealer or sealed connection to protect a modular umbrella system from environmental conditions. In embodiments, a core umbrella assembly or module 130 may comprise two or more motors or motor assemblies. Although the specification may refer to a motor, a motor may be a motor assembly with a motor controller, a motor, a stator, a rotor and/or a drive/output shaft. In embodiments, a core umbrella assembly 130 may comprise an azimuth rotation motor 131, an elevation motor 132, and/or a spoke expansion/retraction motor 133. In embodiments, an azimuth rotation motor 131 may cause a core umbrella assembly 130 to rotate clockwise or counterclockwise about a base assembly or module 110 or a table connection assembly 180. In embodiments, an azimuth rotation motor 131 may cause a core umbrella assembly 130 to rotate about an azimuth axis. In embodiments, a core umbrella assembly or module 130 may rotate up to 360 degrees with respect to a base assembly or module 130.

In embodiments, an elevation motor 132 may cause an upper core assembly 140 to rotate with respect to a lower core assembly 142. In embodiments, an elevation motor 130 may rotate an upper core assembly 140 between 0 to 90 degrees with respect to the lower core assembly 142. In embodiments, an elevation motor 130 may rotate an upper module or assembly 140 between 0 to 30 degrees with respect to a lower assembly or module 142. In embodiments, an original position may be where an upper core assembly 140 is positioned in line and above the lower core assembly 142, as is illustrated in FIG. 1.

In embodiments, a spoke expansion motor 133 may be connected to an expansion and sensor assembly module 160 via a second extension assembly or module 150 and cause spoke or arm support assemblies in a spoke expansion sensor assembly module 160 to deploy or retract outward and/or upward from an expansion sensor assembly module 160. In embodiments, an expansion extension assembly module 160 may comprise a rack gear and spoke connector assemblies (or arms). In embodiments, a spoke expansion motor 133 may be coupled and/or connected to a hollow tube via a gearing assembly, and may cause a hollow tube to move up or down (e.g., in a vertical direction). In embodiments, a hollow tube may be connected and/or coupled to a rack gear, which may be connected and/or coupled to spoke connector assemblies. In embodiments, movement of a hollow tube in a vertical direction may cause spoke assemblies and/or arms to be deployed and/or retracted. In embodiments, spoke connector assemblies and/or arms may have a corresponding and/or associated gear at a vertical rack gear.

In embodiments, a core assembly or module 130 may comprise motor control circuitry 134 (e.g., a motion control board 134) that controls operation of an azimuth motor 131, an elevation motor 132 and/or an expansion motor 133, along with other components and/or assemblies. In embodiments, the core assembly module 130 may comprise one or more batteries 135 (e.g., rechargeable batteries) for providing power to electrical and mechanical components in the modular umbrella system 100. For example, one or more batteries 135 may provide power to motion control circuitry 134, an azimuth motor 131, an expansion motor 133, an elevation motor 132, a camera 137, a proximity sensor 138, a near field communication (NFC) sensor 138. In embodiments, one or more batteries 135 may provide power to an integrated computing device 136, although in other embodiments, an integrated computing device 136 may also comprise its own battery (e.g., rechargeable battery).

In embodiments, the core assembly 130 may comprise a separate and/or integrated computing device 136. In embodiments, a separate computing device 136 may comprise a Raspberry Pi computing device, other single-board computers and/or single-board computing device. Because a modular umbrella shading system has a limited amount of space, a single-board computing device is a solution that allows for increased functionality without taking up too much space in an interior of a modular umbrella shading system. In embodiments, a separate computing device 136 may handle video, audio and/or image editing, processing, and/or storage for a modular umbrella shading system 100 (which are more data intensive functions and thus require more processing bandwidth and/or power). In embodiments, an upper core assembly 140 may comprise one or more rechargeable batteries 135, a motion control board (or motion control circuitry) 134, a spoke expansion motor 133 and/or a separate and/or integrated computing device 136.

In embodiments, a core assembly connector/cover 141 may cover and/or secure a connector between an upper core assembly 140 and a lower core assembly 142. In embodiments, a core assembly connector and/or cover 141 may provide protection from water and/or other environmental conditions. In other words, a core assembly connector and/or cover 141 may make a core assembly 130 waterproof and/or water resistant and in other environments, may protect an interior of a core assembly from sunlight, cold or hot temperatures, humidity and/or smoke. In embodiments, a core assembly connector/cover 141 may be comprised of a rubber material, although a plastic and/or fiberglass material may be utilized. In embodiments, a core assembly connector/cover 141 may be comprised of a flexible material, silicone, and/or a membrane In embodiments, a core assembly connector/cover 141 may be circular and/or oval in shape and may have an opening in a middle to allow assemblies and/or components to pass freely through an interior of a core assembly connector or cover 141. In embodiments, a core assembly connector/cover 141 may adhere to an outside surface of an upper core assembly 140 and a lower core assembly 142. In embodiments, a core assembly connector/cover 141 may be connected, coupled, fastened and/or have a grip or to an outside surface of the upper core assembly 140 and the lower core assembly 142. In embodiments, a core assembly connector and/or cover 141 may be connected, coupled, adhered and/or fastened to a surface (e.g., top or bottom surface) of an upper core assembly and/or lower core assembly 142. In embodiments, a core assembly connector/cover 141 may cover a hinging assembly and/or reparation point, springs, and wires that are present between an upper core assembly 140 and/or a lower core assembly 142.

In embodiments, a core assembly or module 130 may comprise one or more cameras 137. In embodiments, one or more cameras 137 may be capture images, videos and/or sound of an area and/or environment surrounding a modular umbrella system 100. In embodiments, a lower core assembly 142 may comprise one or more cameras 137. In embodiments, a camera 137 may only capture sound if a user selects a sound capture mode on a modular umbrella system 100 (e.g., via a button and/or switch) or via a software application controlling operation of a modular umbrella system (e.g., a microphone or recording icon is selected in a modular umbrella system software application).

In embodiments, a core assembly 130 may comprise a power button to manually turn on or off power to components of a modular umbrella system. In embodiments, a core assembly or module 130 may comprise one or more proximity sensors 138. In embodiments, one or more proximity sensors 138 may detect whether or not an individual and/or subject may be within a known distance from a modular umbrella system 100. In embodiments, in response to a detection of proximity of an individual and/or subject, a proximity sensor 138 may communicate a signal, instruction, message and/or command to motion control circuitry (e.g., a motion control PCB 134) and/or a computing device 136 to activate and/or deactivate assemblies and components of a modular umbrella system 100. In embodiments, a lower core assembly 142 may comprise a proximity sensor 138 and a power button. For example, a proximity sensor 138 may detect whether an object is within proximity of a modular umbrella system and may communicate a message to a motion control PCB 134 to instruct an azimuth motor 131 to stop rotating a base assembly or module.

In embodiments, a core assembly or module 130 may comprise a near-field communication (NFC) sensor 139. In embodiments, a NFC sensor 139 may be utilized to identify authorized users of a modular umbrella shading system 100. In embodiments, for example, a user may have a mobile computing device with a NFC sensor which may communicate, pair and/or authenticate in combination with a modular umbrella system NFC sensor 139 to provide user identification information. In embodiments, a NFC sensor 139 may communicate and/or transmit a signal, message, command and/or instruction based on a user's identification information to computer-readable instructions resident within a computing device and/or other memory of a modular umbrella system to verify a user is authenticated and/or authorized to utilize a modular umbrella system 100.

In embodiments, a core assembly or module 130 may comprise a cooling system and/or heat dissipation system 143. In embodiments, a cooling system 143 may be one or more channels in an interior of a core assembly or module 130 that direct air flow from outside a modular umbrella system across components, motors, circuits and/or assembles inside a core assembly 130. For example, one or more channels and/or fins may be coupled and/or attached to components, motors and/or circuits, and air may flow through channels to fins and/or components, motors and/or circuits. In embodiments, a cooling system 143 may lower operating temperatures of components, motors, circuits and/or assemblies of a modular umbrella system 100. In embodiments, a cooling system 143 may also comprise one or more plates and/or fins attached to circuits, components and/or assemblies and also attached to channels to lower internal operating temperatures. In embodiments, a cooling system 143 may also move hot air from electrical and/or mechanical assemblies to outside a core assembly. In embodiments, a cooling system 143 may be fins attached to or vents in a body of a core assembly 130. In embodiments, fins and/or vents of a cooling system 143 may dissipate heat from electrical and mechanical components and/or assemblies of the core module or assembly 130.

In embodiments, a separate, detachable and/or connectable skin may be attached, coupled, adhered and/or connected to a core module assembly 130. In embodiments, a detachable and/or connectable skin may provide additional protection for a core assembly module against water, smoke, wind and/or other environmental conditions and/or factors. In embodiments, a skin may adhere to an outer surface of a core assembly.130. In embodiments, a skin may have a connector on an inside surface of the skin and core assembly 130 may have a mating receptacle on an outside surface. In embodiments, a skin may magnetically couple to a core assembly 130. In embodiments, a skin may be detachable and removable from a core assembly so that a skin may be changed for different environmental conditions and/or factors. In embodiments, a skin may connect to an entire core assembly. In embodiments, a skin may connect to portions of an upper core assembly 140 and/or a lower core assembly 142. In embodiments, a skin may not connect to a middle portion of a core assembly 130 (or a core assembly cover connector 141). In embodiments, a skin may be made of a flexible material to allow for bending of a modular umbrella system 100. In embodiments, a base assembly 110, a first extension assembly 120, a core module assembly 130, a second extension assembly 140 and/or an arm extension and sensor assembly 160 may also comprise one or more skin assemblies. In embodiments, a skin assembly may provide a cover for a majority of all of a surface area one or more of the base assembly, first extension assembly 120, core module assembly 130, second extension assembly 150 and/or arm extension sensor assembly 160. In embodiments, a core assembly module 130 may further comprise channels on an outside surface. In embodiments, a skin assembly may comprise two pieces. In embodiments, a skin assembly may comprise edges and/or ledges. In embodiments, edges and/or ledges of a skin assembly may be slid into channels of a core assembly module 130. In embodiments, a base assembly 110, a first extension assembly 120, a second extension assembly 140 and/or an arm expansion sensor assembly 160 may also comprise an outer skin assembly. In embodiments, skin assemblies for these assemblies may be uniform to present a common industrial design. In embodiments, skin assemblies may be different if such as a configuration is desired by a user. In embodiments, skin assemblies may be comprise of a plastic, a hard plastic, fiberglass, aluminum, other light metals (including aluminum), and/or composite materials including metals, plastic, wood. In embodiments, a core assembly module 130, a first extension assembly 120, a second extension assembly 150, an arm expansion sensor assembly 160, and/or a base assembly 110 may be comprised of aluminum, light metals, plastic, hard plastics, foam materials, and/or composite materials including metals, plastic, wood. In embodiments, a skin assembly may be provide protection from environmental conditions (such as sun, rain, and/or wind).

In embodiments, a second extension assembly 150 connects and/or couples a core assembly module 130 to an expansion assembly sensor module (and/or arm extension assembly module) 160. In embodiments, an expansion sensor assembly module 160 may have universal connectors and/or receptacles on both ends to connect or couple to universal receptacles and/or connectors, on the core assembly 130 and/or expansion sensor assembly module 160. FIG. 1 illustrates that a second extension assembly or module 150 may have three lengths. In embodiments, a second extension assembly 150 may have one of a plurality of lengths depending on how much clearance a user and/or owner may like to have between a core assembly module 130 and spokes of an expansion sensor assembly or module 160. In embodiments, a second extension assembly or module 150 may comprise a hollow tube and/or channels for wires and/or other components that pass through the second extension assembly or module 150. In embodiments, a hollow tube 249 may be coupled, connected and/or fixed to a nut that is connected to, for example, a threaded rod (which is part of an expansion motor assembly). In embodiments, a hollow tube 249 may be moved up and down based on movement of the threaded rod. In embodiments, a hollow tube in a second extension assembly may be replaced by a shaft and/or rod assembly.

In embodiments, an expansion and sensor module 160 may be connected and/or coupled to a second extension assembly or module 150. In embodiments, an expansion and sensor assembly or module 160 may be connected and/or coupled to a second extension assembly or module 150 via a universal connector. In embodiments, an expansion and sensor assembly or module 160 may comprise an arm or spoke expansion sensor assembly 162 and a sensor assembly housing 168. In embodiments, an expansion and sensor assembly or module 160 may be connected to a hollow tube 249 and thus coupled to a threaded rod. In embodiments, when a hollow tube moves up and down, an arm or spoke expansion assembly 162 opens and/or retracts, which causes spokes/blades 164 of an arm extension assembly 163. In embodiments, arms, spokes and/or blades 164 may detachably connected to the arm or spoke support assemblies 163.

In embodiments, an expansion and sensor assembly module 160 may have a plurality of arms, spokes or blades 164 (which may be detachable or removable). Because the umbrella system is modular and/or adjustable to meet needs of user and/or environment, an arm or spoke expansion assembly 162 may not have a set number of arm, blade or spoke support assemblies 163. In embodiments, a user and/or owner may determine and/or configure a modular umbrella system 100 with a number or arms, spokes, or blades extensions 163 (and thus detachable spokes, arms and/or blades 164) necessary for a certain function and attach, couple and/or connect an expansion sensor assembly or module 160 with a spoke expansion assembly 162 with a desired number of blades, arms or spoke connections to a second extension module or assembly 150 and/or a core module assembly or housing 130. Prior umbrellas or shading systems utilize a set or established number of ribs and were not adjustable or configurable. In contrast, a modular umbrella system 100 described herein has an ability to have a detachable and adjustable expansion sensor module 162 comprising an adjustable number of arm/spoke/blade support assemblies or connections 163 (and therefore a flexible and adjustable number of arms/spokes/blades 164), which provides a user with multiple options in providing shade and/or protection. In embodiments, expansion and sensor expansion module 160 may be detachable or removable from a second extension module 150 and/or a core assembly module 130 and also one or more spokes, arms and/or assemblies 164 may be detachable or removable from arm or spoke support assemblies 163. Therefore, depending on the application or use, a user, operator and/or owner may detachably remove an expansion and sensor module or assembly 160 having a first number of arm/blade/spoke support assemblies 163 and replace it with a different expansion sensor module or assembly 160 having a different number of arm/blade/spoke support assemblies 163.

In embodiments, arms, blades and/or spokes 164 may be detachably connected and/or removable from one or more arm support assemblies 163. In embodiments, arms, blades, and/or spokes 164 may be snapped, adhered, coupled and/or connected to associated arm support assemblies 163. In embodiments, arms, blades and/or spokes 164 may be detached, attached and/or removed before deployment of the arm extension assemblies 163.

In embodiments, a shading fabric 165 may be connected, attached and/or adhered to one or more arm extension assemblies 163 and provide shade for an area surrounding, below and/or adjacent to a modular umbrella system 100. In embodiments, a shading fabric (or multiple shading fabrics) may be connected, attached, and/or adhered to one or more spokes, arms and/or blades 164. In embodiments, a shading fabric or covering 165 may have integrated therein, one or more solar panels and/or cells (not shown). In embodiments, solar panels and/or cells may generate electricity and convert the energy from a solar power source to electricity. In embodiments, solar panels may be coupled to a shading power charging system (not shown). In embodiments, one or more solar panels and/or cells may be positioned on top of a shading fabric 165. In embodiments, one or more solar panels and/or cells may be connected, adhered, positioned, attached on and/or placed on a shading fabric 165.

In embodiments, an expansion sensor assembly or module 160 may comprise one or more audio speakers 167. In embodiments, an expansion sensor assembly or module 160 may further comprise an audio/video transceiver. In embodiments, a core assembly 130 may comprise and/or house an audio/video transceiver (e.g., a Bluetooth or other PAN transceiver, such as Bluetooth transceiver 197). In embodiments, an expansion sensor assembly or module 160 may comprise an audio/video transceiver (e.g., a Bluetooth and/or PAN transceiver) In embodiments, an audio/video transceiver in an expansion sensor assembly or module 160 may receive audio signals from an audio/video transceiver 197 in a core assembly 130, convert to an electrical audio signal and reproduce the sound on one or more audio speakers 167, which projects sound in an outward and/or downward fashion from a modular umbrella system 100. In embodiments, one or more audio speakers 167 may be positioned and/or integrated around a circumference of an expansion sensor assembly or module 160.

In embodiments, an expansion sensor assembly or module 160 may comprise one or more LED lighting assemblies 166. In embodiments, one or more LED lighting assemblies 166 may comprise bulbs and/or LED lights and/or a light driver and/or ballast. In embodiments, an expansion sensor assembly or module 160 may comprise one or more LED lighting assemblies positioned around an outer surface of the expansion sensor assembly or module 160. In embodiments, one or more LED lighting assemblies 166 may drive one or more lights. In embodiments, a light driver may receive a signal from a controller or a processor in a modular umbrella system 100 to activate/deactivate LED lights. The LED lights may project light into an area surrounding a modular umbrella system 100. In embodiments, one or more lighting assemblies 166 may be recessed into an expansion or sensor module or assembly 160.

In embodiments, an arm expansion sensor housing or module 160 may also comprise a sensor housing 168. In embodiments, a sensor housing 168 may comprise one or more environmental sensors, one or more telemetry sensors, and/or a sensor housing cover. In embodiments, one or more environmental sensors may comprise one or more air quality sensors, one or more UV radiation sensors, one or more digital barometer sensors, one or more temperature sensors, one or more humidity sensors, one or more carbon monoxide sensors, one or more carbon dioxide sensors, one or more gas sensors, one or more radiation sensors, one or more interference sensors, one or more lightning sensors, one or more and/or one or more wind speed sensors. In embodiments, one or more telemetry sensors may comprise a GPS/GNSS sensor and/or one or more digital compass sensors. In embodiments, a sensor housing 168 may also comprise one or more accelerometers and/or one or more gyroscopes. In embodiments, a sensor housing 168 may comprise sensor printed circuit boards and/or a sensor cover (which may or may not be transparent). In embodiments, a sensor printed circuit board may communicate with one or more environmental sensors and/or one or more telemetry sensors (e.g., receive measurements and/or raw data), process the measurements and/or raw data and communicate sensor measurements and/or data to a motion control printed circuit board (e.g., controller) and/or a computing device (e.g., controller and/or processor). In embodiments, a sensor housing 168 may be detachably connected to an arm connection housing/spoke connection housing to allow for different combinations of sensors to be utilized for different umbrellas. In embodiments, a sensor cover of a sensor housing 168 may be clear and/or transparent to allow for sensors to be protected from an environment around a modular umbrella system. In embodiments, a sensor cover may be moved and/or opened to allow for sensors (e.g., air quality sensors to obtain more accurate measurements and/or readings). In embodiments, a sensor printed circuit board may comprise environmental sensors, telemetry sensors, accelerometers, gyroscopes, processors, memory, and/or controllers in order to allow a sensor printed circuit board to receive measurements and/or readings from sensors, process received sensor measurements and/or readings, analyze sensor measurements and/or readings and/or communicate sensor measurements and/or readings to processors and/or controllers in a core assembly or module 130 of a modular umbrella system 100.

In embodiments, a modular umbrella shading system 100 may comprise a lightning sensor. In embodiments, a lightning sensor may be installed on a base assembly 110. In embodiments, a lightning sensor may be installed on a core module or core assembly 130. In embodiments, a lightning sensor may be installed on a sensor and/or expansion assembly or module 160. In embodiments, a lightning sensor may be installed, attached, fastened and/or positioned on a shading fabric, an arm, and/or a blade of an intelligent shading system. In embodiments, a lightning sensor may be installed on and/or within a sensor housing 168. In embodiments, a lightning sensor may be installed on and/or connected, adhered or coupled to a skin of an intelligent umbrella and/or shading system. In embodiments, a lightning sensor may detect lightning conditions around an area or in a vicinity of an intelligent umbrella and/or shading system. In embodiments, a lightning sensor may detect an interference signal strength and/or pattern in an atmosphere that corresponds to either intra-cloud lightning conditions and/or occurrences, and/or to cloud-to-ground lightning conditions and/or occurrences. In embodiments, a lightning sensor may have tolerance conditions set. In embodiments, a lightning sensor may also able to measure and/or calculate a distance from a location with an intelligent shading system and/or intelligent umbrella to a location where a lightning event and/or condition has occurred. In embodiments, a lightning sensor may be an Austria Microsystems Franklin AS3935 digital lightning sensor. In embodiments, a lightning sensor may calculate signal measurements, signal strengths, other conditions (e.g., based at least on interference received with respect to lightning conditions) and/or distances, and may communicate signal measurements, signal strengths, other conditions and/or distances to a memory in an intelligent umbrella for storage. In embodiments, lightning sensor signal measurements, strengths, conditions and/or distances may be communicated to a computing device 136 where one or more processors may execute computer-readable instructions to 1) receive lightning sensor signal measurements, strength measurements, conditions and/or distances, 2) process such measurements and/or conditions; and 3) generate commands, instructions, messages and/or signals to cause actions by other components and/or assemblies in an intelligent umbrella and/or robotic shading system in response to measurements and/or conditions captured and/or received by a lightning sensor. In embodiments, computer-readable instructions fetched from one or more memory modules and executed by a processor of a computing device 136 may generate and communicate commands to a motion control board 134 to cause different motor assemblies to move assemblies (e.g., an upper portion of a core assembly and/or are support assemblies to extend arms) of an intelligent umbrella and/or shading system. In embodiments, because portions of an intelligent umbrella and/or shading system are metallic, computer-readable instructions executed by one or more processors may generate and communicate commands, messages, signals or instructions to cause an expansion and sensor assembly 160 to retract arms and/or spokes 164 to a rest or closed position and/or to turn off other sensors in a sensor housing to protect sensors from lightning strikes. In embodiments, because portions of an intelligent umbrella and/or shading system are metallic and conductive, computer-readable instructions executed by one or more processors may generate and communicate commands, messages, signals or instructions to cause an expansion and sensor assembly 160, a core assembly 130 and/or a base assembly to turn off or deactivate other components, motors, processors and/or sensors to prevent damage from electrical (voltage and/or current surges) in a sensor housing to protect sensors from lightning strikes. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system 166 to generate lights and/or rays indicating a dangerous situation is occurring or going to occur. In addition, because lightning strikes can damage electrical components, a lightning sensor's measurements, conditions and/or distances may be communicated to a processor and computer-readable instructions executed by one or more processors may generate and communicate commands to a power subsystem (e.g., a rechargeable battery and/or power charging assembly) to power off an intelligent umbrella and/or shading system 100 and/or to power off and/or deactivate components and/or assemblies susceptible to lightning strikes and large voltage and/or current surges associated therewith. Advantages of having a lightning sensor integrated within an intelligent umbrella and/or shading system 100 and/or attached, connected or coupled thereto, are that a lightning sensor may identify dangerous conditions, shut down portions of an intelligent umbrella and/or shading system and warn users of a potentially damaging and dangerous situation when a user or operator may not be aware such dangerous conditions are present.

In embodiments, a modular umbrella shading system 100 may comprise an interference sensor (e.g., a noise sensor and/or a wireless noise or interference sensor or scanner). In embodiments, such an interference sensor may identify sources and strengths of noise and/or interference in a vicinity of an intelligent umbrella and/or robotic shading system 100. For example, interference and/or noise may be radio frequency interference, electromagnetic interference, randomly generated noise, impulse noise, acoustic noise, thermal noise, etc. For example, noise and/or interference may be present in certain wireless communication spectrum bands. In embodiments, an interference sensor may be installed or located on a base assembly 110. In embodiments, an interference sensor may be installed or located on a core module or core assembly 130. In embodiments, an interference sensor may be installed or located on a sensor and/or expansion assembly or module 160. In embodiments, an interference sensor may be installed, position, attached, and/or connected to a shading fabric, an arm support assembly and/or an arm or blade of an intelligent umbrella. In embodiments, an interference sensor may be installed on and/or within a sensor housing 168. In embodiments, a lightning sensor may be installed on and/or connected, adhered or coupled to a skin of an intelligent umbrella and/or shading system. In embodiments, an interference sensor may detect noise and/or interference conditions around or in a vicinity of an intelligent umbrella and/or shading system. In embodiments, an interference sensor may detect and/or measure an interference signal strength (e.g., interference that may impact operations of wireless transceivers) and/or an interference type that corresponds to noise sources generating noise and interference in an environment or that is projected and/or communicated into an area around an intelligent umbrella and/or shading system. In embodiments, the noise and/or interference may be from natural sources (e.g., electromagnetic waves, sound waves, impulse waves), from mechanical devices, from acoustic devices, and/or other electronic devices (e.g., home security systems, other routers, wireless printers, wireless transmitters and/or receivers, and/or ICs). In embodiments, an interference sensor may have tolerance conditions established and may identify different type of noise and/or interference. In embodiments, an interference sensor may also able to measure and/or calculate a type of noise and/or interference, where a source may be located and how often the noise and/or interference may be detected and/or measured. In embodiments, an interference sensor may calculate signal measurements, signal strengths, and/or other conditions (e.g., is it repetitive and/or randomly occurring and is it based at least on other conditions associated with measured interference). In embodiments, an interference sensor may communicate signal measurements, signal strengths, other conditions and/or locations to a memory for storage. In embodiments, interference sensor signal measurements, strengths, conditions and/or distances may be communicated to a computing device 136 where one or more processors may execute computer-readable instructions to 1) receive interference sensor signal measurements, strength measurements, and/or conditions; and/or 2) process such measurements and/or conditions. In embodiments, one or more processors (e.g., in a computing device 136) in conjunction with computer-readable instructions executed by the one or more processors may generate commands, instructions, messages and/or signals to cause actions by other components and/or assemblies in response to measurements and/or conditions captured and/or received by an interference sensor. In embodiments, computer-readable instructions fetched from one or more memory modules and executed by a processor (e.g., of a computing device 136) may generate and communicate commands to a motion control board 134 (or other circuits or circuit assemblies) to cause different motor assemblies to move assemblies of an intelligent umbrella and/or shading system to different locations and/or positions. In embodiments, interference sensor measurements may identify that cellular communications may not be reliable in an area around an intelligent umbrella because of a high level of interference in a cellular communications frequency band and computer-readable instructions executable by one or more processors may communicate commands and/or signals to a cellular transceiver to deactivate a cellular transceiver 195. In embodiments, computer-readable instructions executable by a processor may also not communicate any commands, signals, instructions and/or messages to a cellular transceiver 195 until interference and/or noise conditions have improved. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system and/or sound communication system to generate lights and/or audible alerts indicating a dangerous or problematic situation is occurring or going to occur (e.g., high level of impulse noise or EMI). In addition, because high levels of different types of noise can impact performance of specific electrical components, an interference sensor's measurements, conditions and/or distances may be communicated to a processor and computer-readable instructions executed by one or more processors may generate and communicate commands to a power subsystem (e.g., a rechargeable battery and/or power charging assembly) to power to power off and/or deactivate components and/or assemblies susceptible to noise and/or interference. Advantages of having an interference sensor integrated within an intelligent umbrella and/or shading system 100 and/or attached, connected or coupled thereto, are that an interference sensor may identify problematic conditions, shut down portions of an intelligent umbrella and/or shading system in response thereto, and/or warn users of a potentially problematic and dangerous situation. In addition, an intelligent umbrella with an interference sensor may operate more efficiently by avoiding certain communication frequency bands having large levels of noise which could impact accuracy of wireless communications.

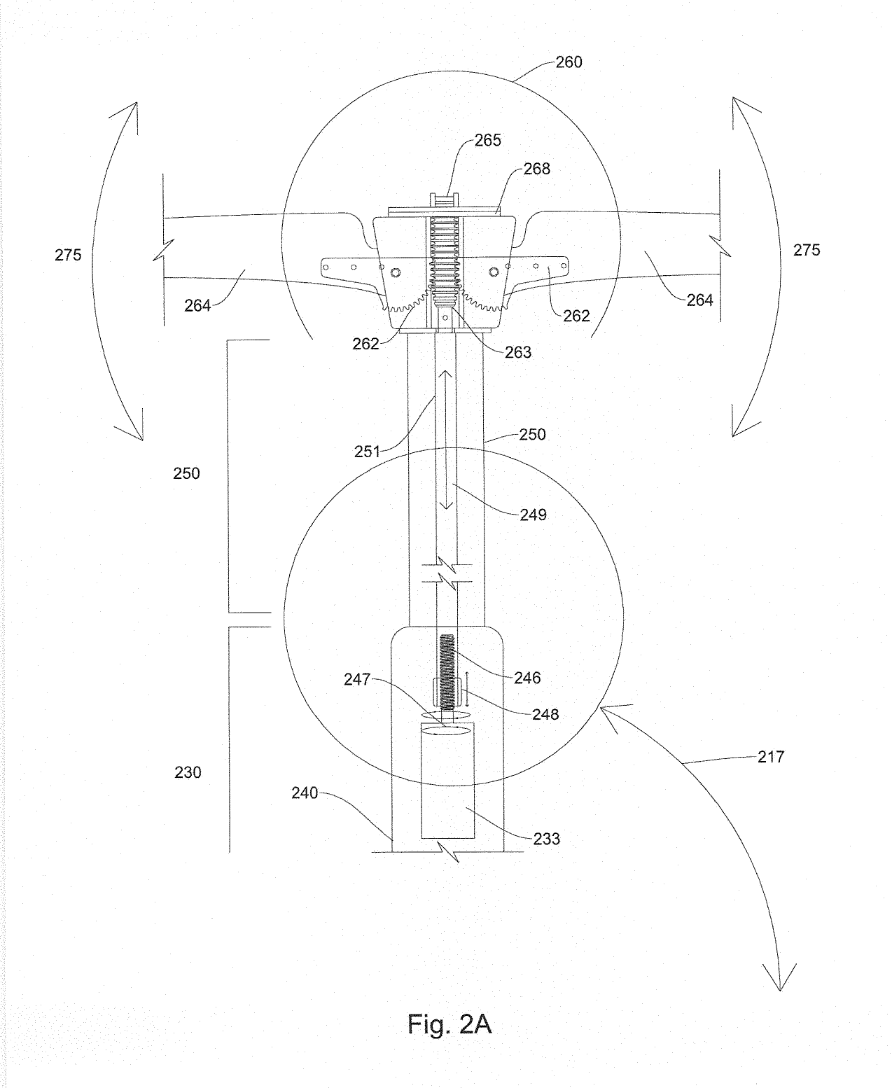

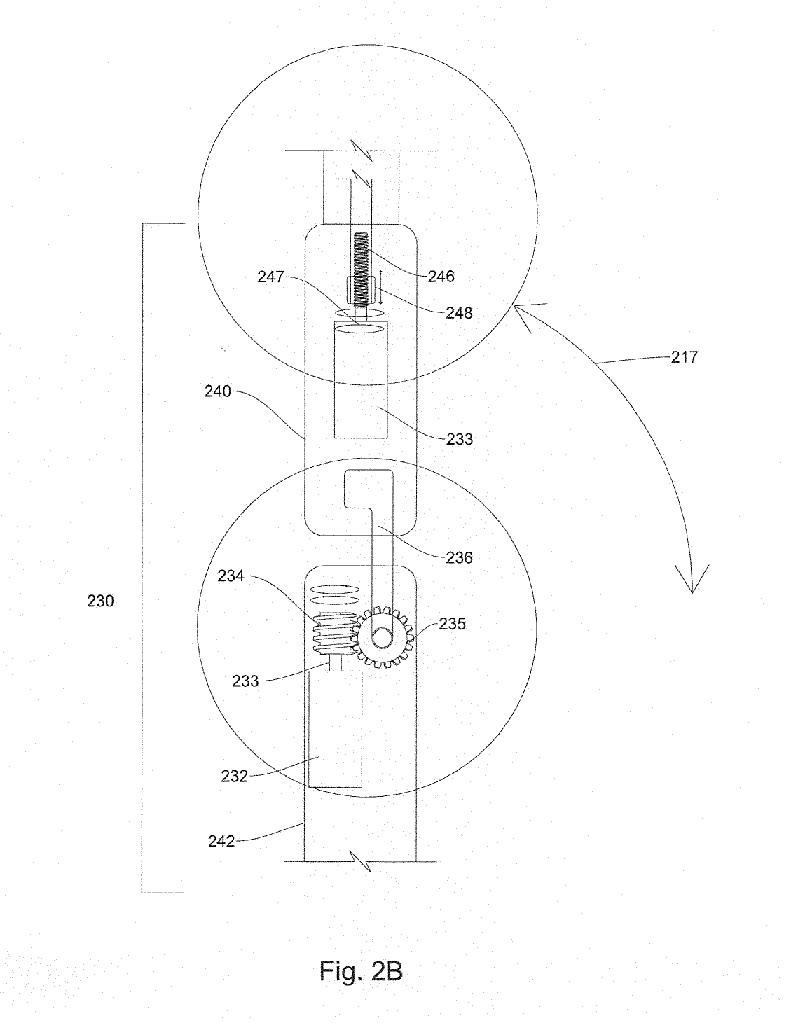

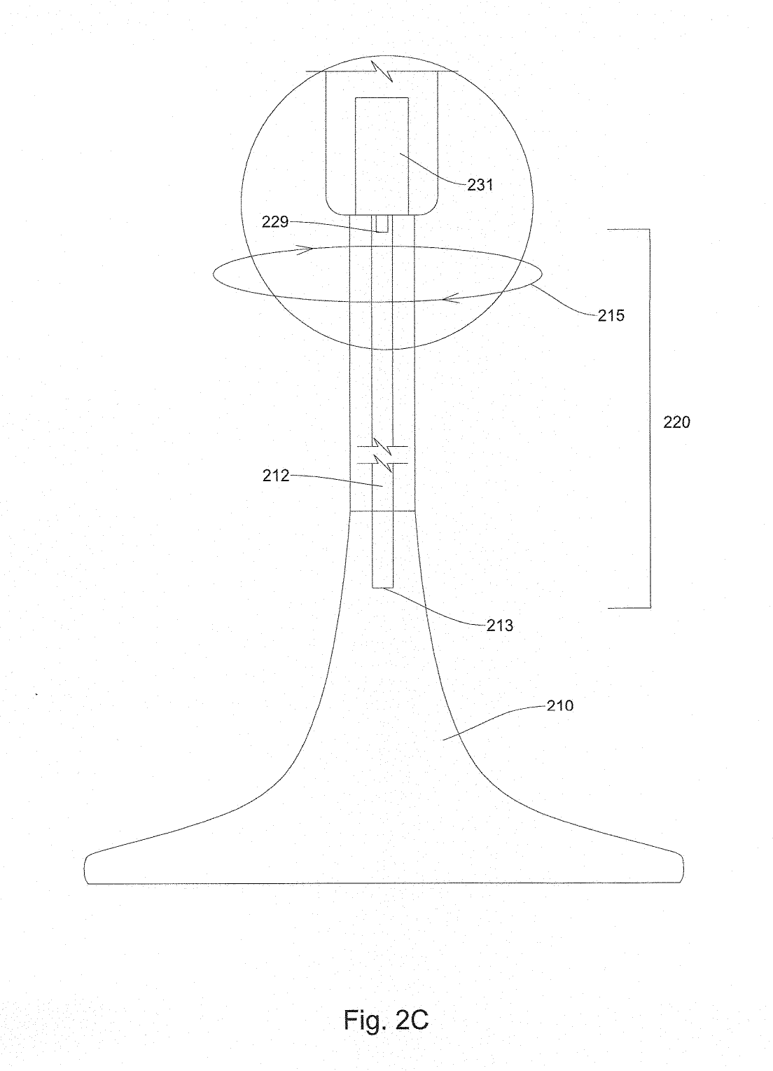

FIG. 2 illustrates a cut-away drawing of mechanical assemblies in a modular umbrella system according to embodiments. In embodiments, a modular umbrella shading assembly 200 may comprise a base assembly 210, a first extension assembly 220, a core assembly or module 230, a base receptacle 213, a force transfer shaft 212, an azimuth motor 231, and/or an azimuth motor shaft 229. In embodiments, a first extension assembly 220 and a core assembly module 230 may rotate in a clockwise or counterclockwise manner direction (as illustrated by reference number 215) with respect to a base assembly 210. In embodiments, an azimuth motor 231 comprises an azimuth motor shaft 229 that may rotate in response to activation and/or utilization of an azimuth motor 231. In embodiments, an azimuth motor shaft 229 may be mechanically coupled (e.g., a gearing system, a friction-based system, etc.) to a force transfer shaft 212. In embodiments, an azimuth motor shaft 229 may rotate in a clockwise and/or counterclockwise direction and in response, a force transfer shaft 212 may rotate in a same and/or opposite direction. In embodiments, a force transfer shaft 212 may pass through a first extension assembly 220 and may be mechanically coupled to a base receptacle 213 in a base assembly 210. In response to, or due to, rotation of force transfer shaft 212 in a base receptacle 213, a first extension assembly 220 and/or a core assembly 230 may rotate with respect to the base assembly 210.

In embodiments, a modular umbrella system 200 may comprise a core assembly 230 which may comprise a lower core assembly 242 and an upper core assembly 240. In embodiments, a lower core assembly 242 may comprise an elevation motor 232, an elevation motor shaft 233, a worm gear 234, and/or a speed reducing gear 235. In embodiments, a speed reducing gear 235 may be connected with a connector to a connection plate 236. In embodiments, a lower core assembly 242 may be mechanically coupled to an upper core assembly 240 via a connection plate 236. In embodiments, a connection plate 236 may be connected to an upper core assembly 240 via a connector and/or fastener. In embodiments, an elevation motor 232 may cause rotation (e.g., clockwise or counterclockwise) of an elevation motor shaft 233, which may be mechanically coupled to a worm gear 234. In embodiments, rotation of an elevation motor shaft 233 may cause rotation (e.g., clockwise or counterclockwise) of a worm gear 234. In embodiments, a worm gear 234 may be mechanically coupled to a speed reducing gear 235. In embodiments, rotation of a worm gear 234 may cause rotation of a speed reducing gear 235 via engagement of channels of a worm gear 234 with teeth of a speed reducing gear 235. In embodiments, a sped reducing gear 235 may be mechanically coupled to a connection plate 236 to an upper core assembly 240 via a fastener or connector. In embodiments, rotation of a speed reducing gear 235 may cause a connection plate 236 (and/or an upper core assembly 240) to rotate with respect to a lower core assembly 242 in a clockwise or counterclockwise direction as is illustrated by reference number 217. In embodiments, an upper core assembly 240 may rotate with respect to the lower core assembly 242 approximately 90 degrees via movement of the connection plate. In embodiments, an upper core assembly 240 may rotate approximately 0 to 30 degrees with respect to the lower core assembly 242 via movement of the connection plate.

In embodiments, an upper core assembly 240 may comprise an extension expansion motor 233 and an extension expansion motor shaft 247. In embodiments, an expansion motor 233 may be activated and may rotate an extension expansion motor shaft 247. In embodiments, an expansion motor shaft 247 may be mechanically coupled to a threaded rod 246 which may be mechanically couple to a travel nut 248 (e.g., a nut may be screwed onto the threaded rod 246). In embodiments, an expansion motor shaft 247 may rotate a threaded rod 246 which may cause a travel nut 248 to move in a vertical direction (e.g., up or down). In embodiments, a travel nut 248 may be mechanically coupled to a connection rod 249. In embodiments, a travel nut 248 may move in vertical direction (e.g., up or down) which may cause a connection rod 249 to move in a vertical direction (e.g., up or down) as is illustrated by reference number 251. In embodiments, a connection rod 249 may be partially positioned and/or located within an upper core assembly 240 and may be partially positioned within a second extension assembly 250. In embodiments, a connection rod 249 and/or a second extension assembly 250 may have varying lengths based on a desired height of a modular umbrella system 200. In embodiments, a connection rod 249 may be mechanically coupled to an expansion assembly shaft 263.

In embodiments, an arm expansion sensor housing or module 260 may comprise an expansion assembly shaft 263, a rack gear 265, one or more spoke/arm expansion assemblies 262, and a sensor module 268. In embodiments, an expansion assembly shaft or hollow tube 263 may be mechanically coupled to a rack gear 265. In embodiments, movement of an expansion shaft or hollow tube 263 up or down in a vertical direction may move a rack gear 265 in a vertical direction (e.g., up or down). In embodiments, one or more spoke expansion assemblies 262 may be mechanically coupled to a rack gear 265. In embodiments, gears on one or more spoke/arm expansion assemblies 262 may engage channels in a rack gear 265. In embodiments, a rack gear 265 may move in a vertical direction (e.g., up or down) which may cause movement of one or more spoke/arm expansion assemblies 262 from an open position (as is illustrated in FIG. 2) to a closed position (or vice versa from a closed position to an open position). In embodiments, movement of one or more spoke/arm expansion assemblies 262 is illustrated by reference number 275 in FIG. 2. In embodiments, spokes/arms 264 may be mechanically coupled to spoke expansion assemblies 262. In embodiments, one or more spokes/arms 264 may be detachable from one or more spoke/arm expansion assemblies 262.

Prior art shading systems utilizing at the most one motor to move a shade into a desired position. Shading systems do not utilize more than one motor and this limits movement of a shade system to track the sun and provide protection to users of a shading system. Accordingly, utilizing of two or more motors in a shading system allow movement of a shading element (or multiple shading elements) to track the sun, to protect a user from other weather elements and/or to capture a large amount of solar energy. These are improvements other shading systems which cannot move and/or rotate about more than one axis. Although, FIGS. 1 and 2 describe a shading system with three motors, additional motors may be utilized to, for example, rotate a shading system (utilizing a motor in a base system next to a surface), additional motors to deploy additional accessories within a shading system core assembly module (e.g., lighting assemblies, wind turbines, camera mounts), or additional motors to deploy accessories within an expansion and sensor assembly module (e.g., deploy sensors, deploy solar panels, move speakers to different positions or orientations and/or move lighting assemblies to different positions and/or orientations).

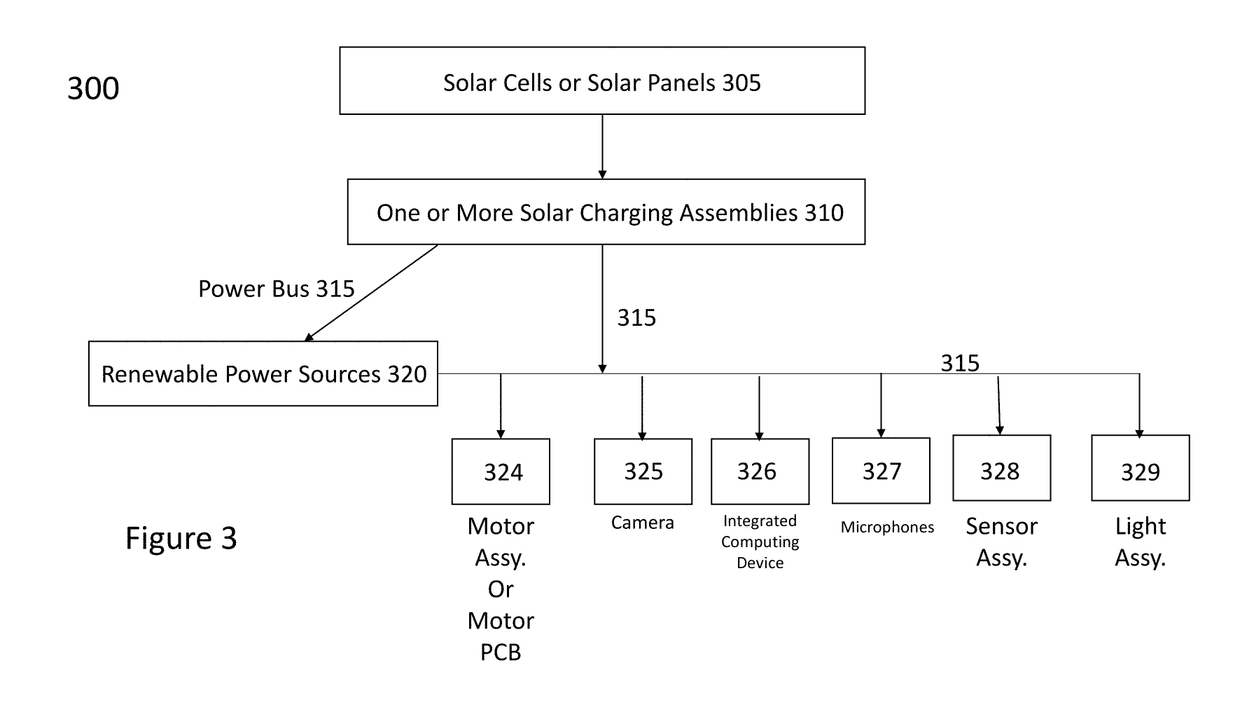

FIG. 3 illustrates a block diagram power subsystem of a parasol, umbrella or shading system according to embodiments. In embodiments, a power subsystem 300 comprises one or more solar cells or solar cell panels 305, one or more solar charging assemblies 310, one or more power buses 315, one or more rechargeable batteries 320, and one or more electrical or electro-mechanical assemblies 324 325 326 327 328 and 329. In embodiments, one or more solar cells or solar cell panels 305 may generate electrical energy or electrical power from a light source (e.g., the sun). In embodiments, one or more solar cells or solar cell panels 305 may transfer power or electrical energy to one or more solar charging assemblies 310. In embodiments, one or more solar charging assemblies 310 may be solar charge controllers. In embodiments, one or more solar charging assemblies 310 may comprise computer interfaces that monitor and control power output from one or more solar cells or solar cell panels. In embodiments, indicators may monitor, control and/or display output power (e.g., one or more LED lighting assemblies may show that power is being supplied and that some power is being output via a solar charging assembly). In embodiments, one or more solar charging assemblies 310 may also display voltage and/or current being supplied from one or more solar panels or solar cell panels and/or may also display voltage and/or current being output by one or more solar charging assemblies 310 as well as displaying how much current is being pulled from a load terminal (and thus supplied to a rechargeable power source, components and/or assemblies).

In embodiments, one or more solar charging assemblies 310 may supply power to one or more rechargeable power sources (e.g., rechargeable batteries) 320. In embodiments, one or more solar charging assemblies 310 may supply power (e.g., voltage and/or current) to a power bus and/or power cables 315. In embodiments, the power supplied to a power bus and/or power cables 315 from one or more solar charging assemblies 310 may be at an approximate level of 12 volts (or between 11 to 17 volts). In embodiments, one or more solar charging assemblies 310 may provide power to a rechargeable power source 320 at a level between 11 and 17 volts (or at approximately 12 volts). In embodiments, a power bus and/or power cables 315 may supply power (e.g., voltage and/or current) to one or more components, assemblies or apparatuses (e.g., one or more electrical or electro-mechanical assemblies 324 325 326 327 328 and 329). For example, component 324 may be a motor control printed circuit board; reference number 325 may be a camera; reference number 326 may be an integrated computing device 326; reference number 327 may be one or more microphones; reference number 328 may be one or more sensor assemblies or sensors; and reference number 329 may be one or more lighting assemblies. In embodiments, components such as a motor control PCB 324, one or more cameras 325, one or more integrated computing devices 326, one or microphones 327, one or more sensors or sensor assemblies 328, and one or more lighting assemblies 329 may not utilize 12 volts and if not then these components and/or assemblies include a voltage regulate to provide a lower voltage, such as 3.3 Volts and/or 5 volts. In embodiments, one or more renewable power sources (e.g., rechargeable batteries) 320 may be placed in a battery housing. In embodiments, one or more battery housings may be placed around a center core assembly.

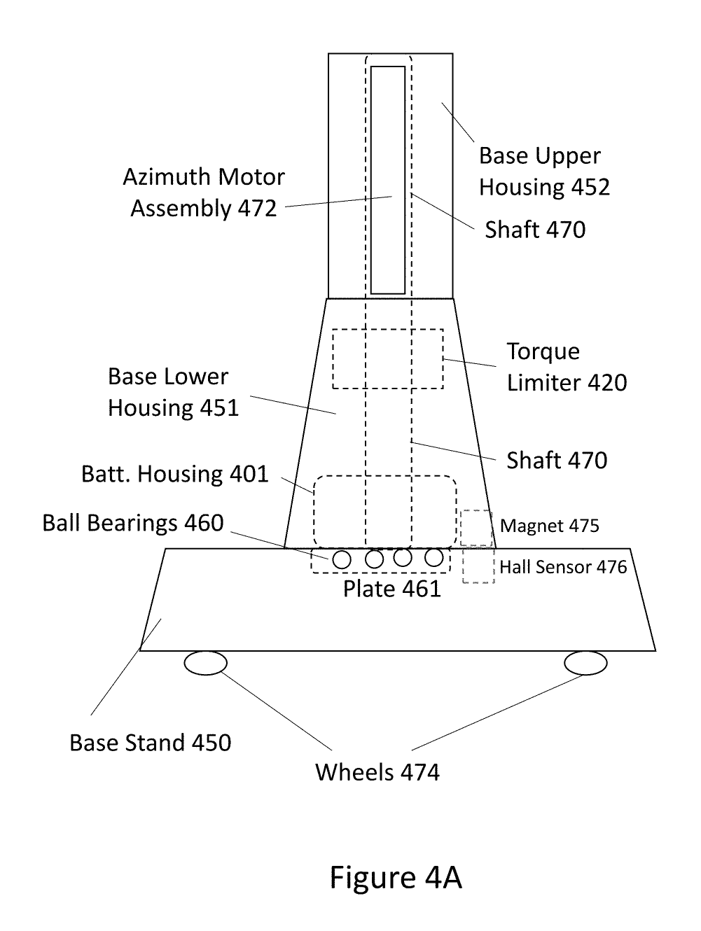

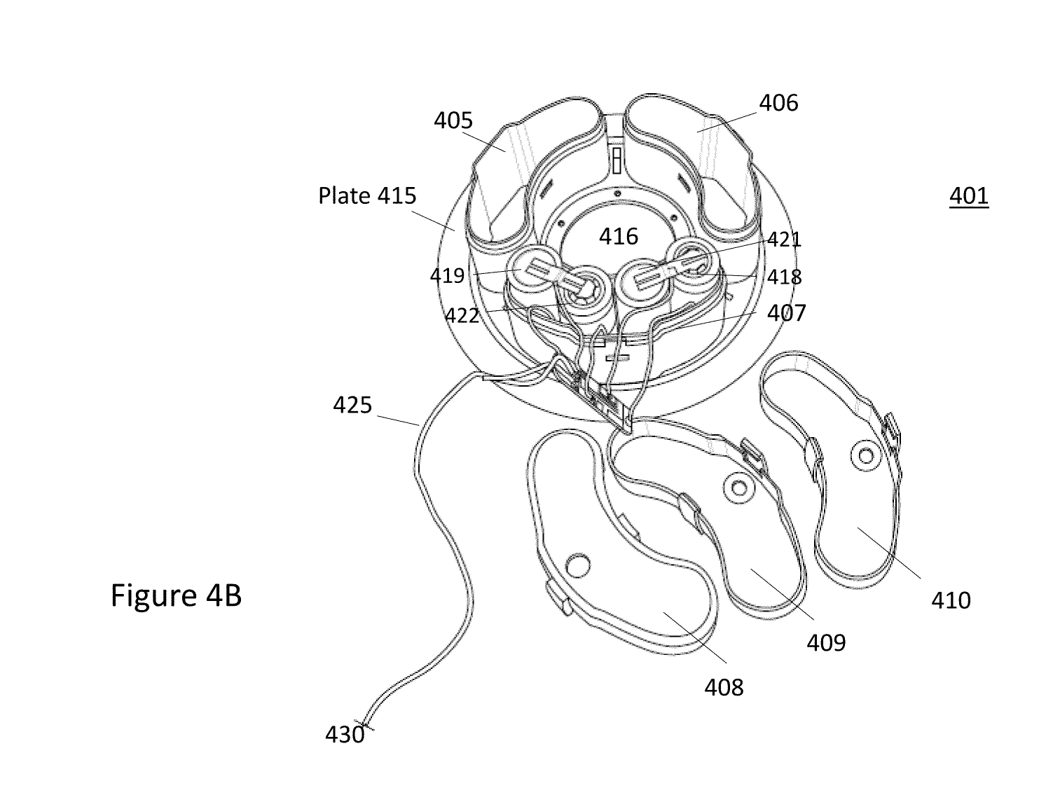

FIG. 4A illustrates a base assembly including a base stand, a base lower housing and base housing according to embodiments. In embodiments, a base assembly may comprise a base stand 450, a base lower housing 451 and a base upper housing 452. In embodiments, a base assembly may be movable. In embodiments, a base stand 450 may comprise one or more wheel assemblies 474, which allow a base stand 450 (and thus the base assembly and umbrella, parasol or shading system) to be able to move. In embodiments, a base stand may comprise one or more plates 461 and one or more ball bearings 460. In embodiments, one or more ball bearings may be inserted into grooves or channels or one or more plates 461. In embodiments, one or more plates 461 may be circular and/or may comprise one or more concentric circles. In embodiments, a base stand 450 may comprise a hall sensor 476 or magnetic detection sensor (although in other embodiments, a base stand 450 may comprise a magnetic or magnetic assembly 475). In embodiments, a base lower housing 451 may comprise a battery housing 401 or power source housing 401. In embodiments, a shaft 470 may run through a base lower housing 451 and a base upper housing 452. In embodiments, a base lower housing may comprise a torque limiter 420, which is connected and/or coupled to a shaft assembly 470. In embodiments, a torque limiter 420 may keep an umbrella and/or shading system from having base assemblies and/or core assemblies broken or malfunctioning during excessive twisting and/or torque from rotation, pulling or pushing of a core assembly (and/or remainder of umbrella, parasol). In embodiments, excessive torque conditions may be caused by motor malfunctioning or an individual grabbing a core assembly and trying to manually move or rotate a core assembly. In embodiments, if a normal amount of torque is placed on a base assembly, then a torque limiter 420 is not engaged and rotation is limited. If an excessive amount of torque is present, then a torque limiter 420 is engaged and a motor assembly is stopped or reduced. In embodiments, a torque limiter may be a clutch or clutch assembly.

In embodiments, a base upper housing 452 may comprise an amizuth motor assembly 472, which may operate in a similar fashion to the azimuth motor assembly 472 described in FIGS. 1A, 1B, or 1C. In embodiments, an azimuth motor assembly 472 may be located in a shaft or tube and may cause a base lower housing 451 and base upper housing 452 (and remainder of an umbrella, parasol or shading system) to rotate in an azimuth direction around a base stand 450. In embodiments, ball bearings 460 in plate 461 allow for smooth rotation of a base lower housing 451 and base upper housing 452 with respect to a base stand. In embodiments, a bottom party or floor of a battery housing 401 may be connected or coupled or touch a plate 461 and/or one or more ball bearings 460. In embodiments, a lower base housing 451 may comprise a magnet or magnetic assembly 475 (although in other embodiments, the lower base housing 451 may comprise a magnetic field sensor of hall sensor 476). In embodiments, a magnet or magnetic assembly 475 and a hall sensor 476 may be utilized to verify that an umbrella's, parasol's or shading system's umbrella knows an orientation of a base stand 450 with respect to the rest of the umbrella, parasol or shading system. If the remainder of the umbrella is not aligned (including the base lower housing) with the base stand 450, then the umbrella, parasol or shading system may not know an orientation (e.g., what direction an umbrella is facing). This impacts many calculations made by the umbrella during initiation or configuration of the umbrella and throws off the sun tracking features of the umbrella, parasol or shading system. Accordingly, the hall sensor 476 is verifying that a magnet 475 is aligned with it and in a position that is known and therefore that the orientation of the umbrella or parasol is known.

FIG. 4B illustrates a rechargeable power source housing according to embodiments. In embodiments, a rechargeable power source housing 401 may comprise one or more power source holders (e.g., battery holders) 405 406 407, one or more power source tops 408 409 410, a circular plate 415, one or more rechargeable power sources 418 419 422 421 and wiring 425 coupled to one or more power buses 430. In embodiments, each of the one or more power source holders 405 406 407 may hold one or more rechargeable power sources 418 419 422 421 (four may be shown in FIG. 4B), but any number of rechargeable batteries may be utilized. In embodiments, one or more rechargeable power sources 418 419 422 421 may be connected to wiring 425 which in turn may be coupled or connected to one or more power buses to provide + or −12 volts. In embodiments, one or more power source tops 408 409 410 may be connected to one or more corresponding power source holders 405 406 407 via a snap fit connector and/or tabs. In embodiments, a circular plate 415 may be adhered or connected to the one or more power source holders 405 406 407. In embodiments, a circular plate 415 and/or power source holders 405 406 407 may be an integrated piece and may be manufactured using additive manufacturing or 3D printing techniques. In embodiments, a circular plate 415 may have a hole 416 in a middle in order to let a tubular assembly (e.g., a shaft 470) to pass through a middle and be able to construct the remainder of the umbrella. In embodiments, a circular plate 415 may be connected, adhered or fastened to either a base assembly or a core assembly module. In embodiments, a rechargeable power source housing 401 may be located in a bottom base housing, although it may be located in any portion of a core assembly module (and potentially base assembly). In embodiments, a rechargeable power source housing 401 may be located in a section of a base assembly

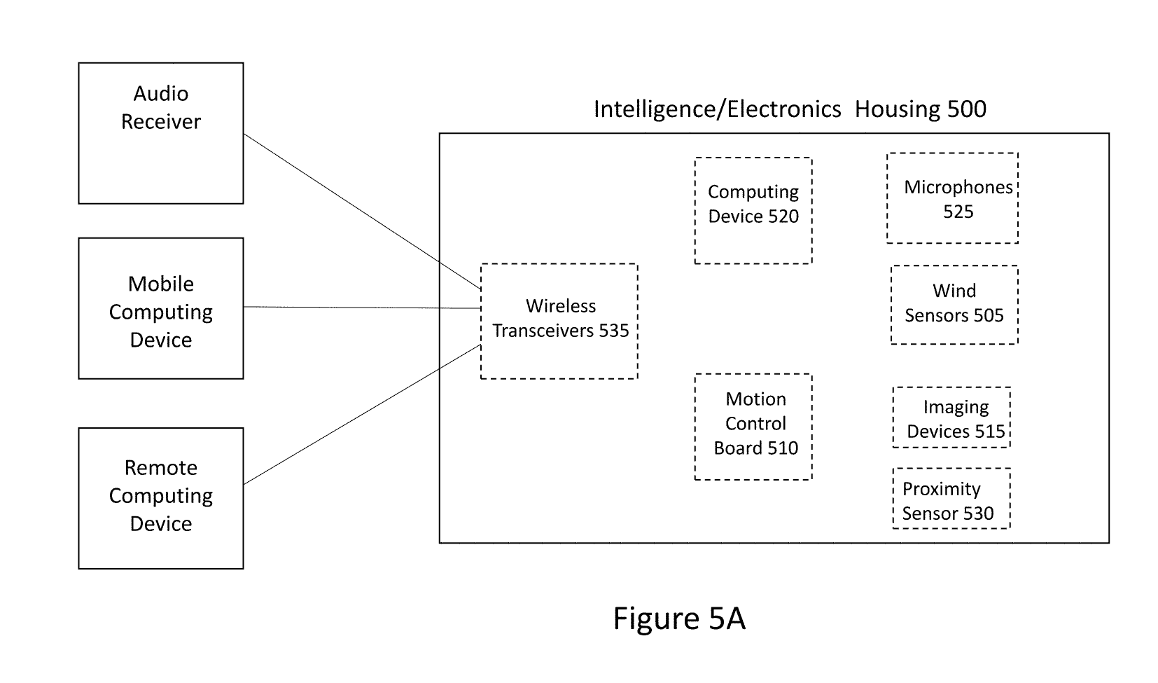

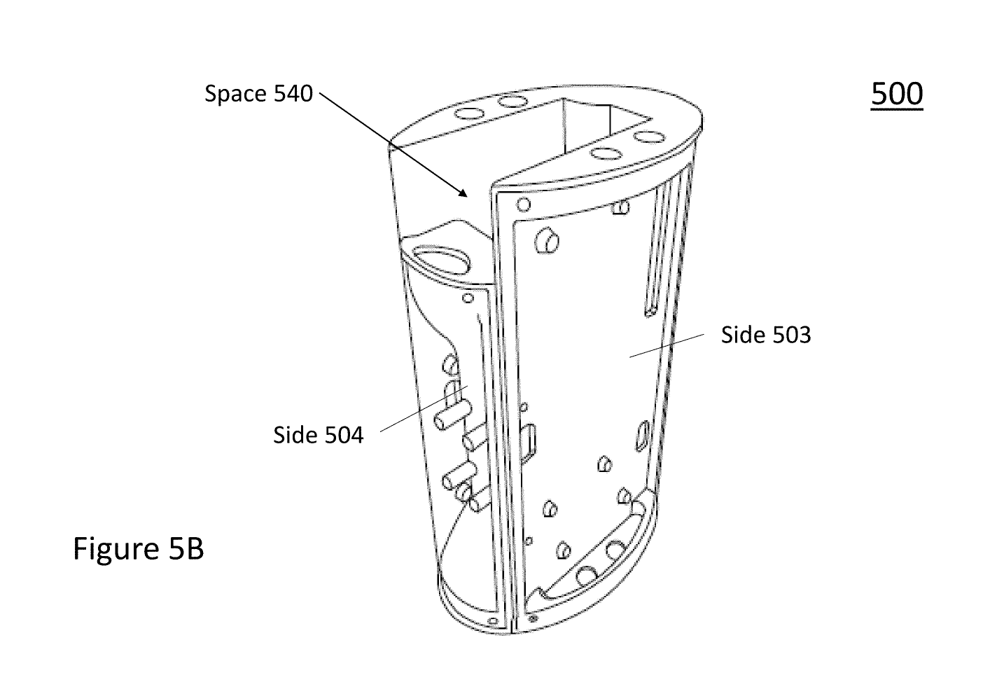

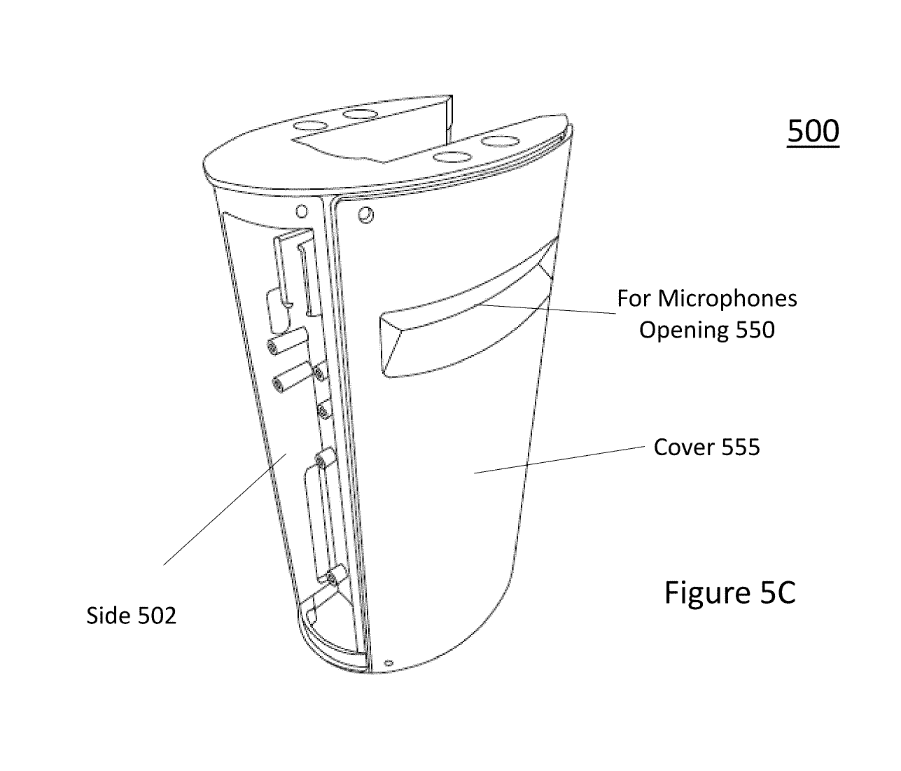

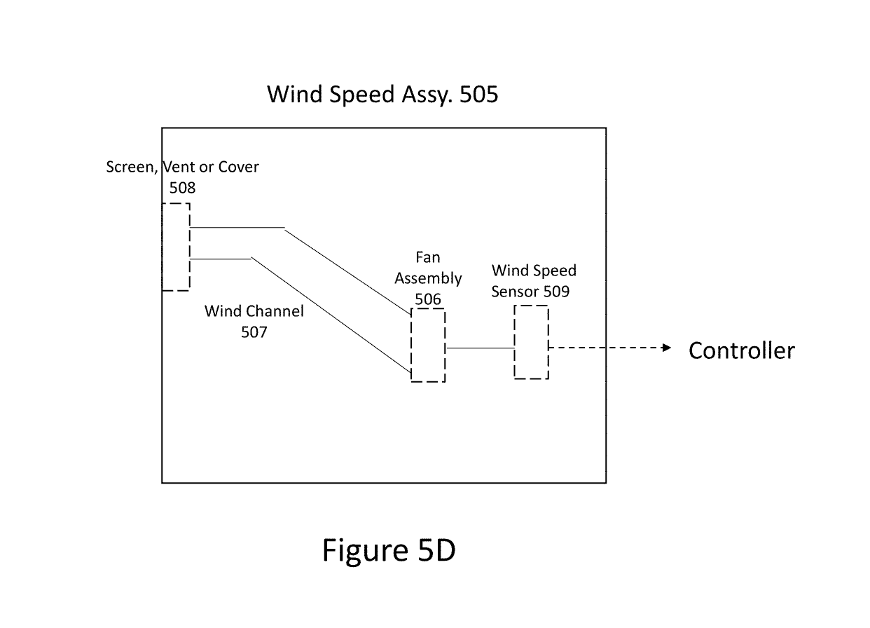

In embodiments, an umbrella, parasol and/or shading system may comprise an intelligence housing (e.g., a brain box) to control a number of functions and/or features of the umbrella, parasol or shading system. FIG. 5A illustrates a block diagram of an intelligence housing according to embodiments. In embodiments, an intelligence housing 500 may be manufactured utilizing additive manufacturing techniques (e.g., 3D printing) and may be comprised of plastic, composite materials or a combination thereof. In embodiments, an intelligent housing 500 may comprise one or more wind sensor assemblies 505, one or more motor control assemblies or motion control board 510, one or more imaging devices 515, one or more integrated computing devices (e.g., Raspberry Pi) 520, one or more microphones or line arrays 525 and one or more proximity sensors 530. In embodiments, an intelligence housing 500 may comprise one or more wireless communication transceivers 535. In embodiments, wireless communication transceivers 535 in an intelligence housing may communicate with a remote computing device (e.g., a server or a cloud-based server), a mobile computing device and/or an audio receiver.

FIG. 5B illustrates a perspective view of an intelligence housing with one side cover removed according to embodiments. FIG. 5C illustrates a perspective view of an intelligence housing with covers installed according to embodiments. In embodiments, an intelligence housing 500 may have four sides. In embodiments, one or more sides may have different thicknesses and/or may have a different shape (e.g., may be a rectangle having a specified thickness or may have different channels be formed therein). In embodiments, adjacent sides of the one or more sides of the intelligence housing may be connected to each other at approximately right angles (e.g., approximately 90 degrees) or from 70 degrees to 110 degrees with respect to each other. In embodiments, a space 540 may be formed or be present in an intelligence housing 500 (e.g., in a middle of an intelligence or electronics housing to allow for passage of a shaft and/or tubular assemblies of the umbrella, parasol or shading housing). In embodiments, a space 540 may be utilized to provide air cooling for printed circuit boards or other components of an intelligence housing by utilizing air movement through the space 540. In embodiments, one or more components, printed circuit boards or sensors (505, 510, 515, 520, 525 or 530—see FIG. 5A) may be mounted or installed on outside surfaces of one or more sides of the intelligence housing 500. FIG. 5B illustrates side 504 and side 503. Alternatively, some components or assemblies may be mounted on an inside surface of an intelligence housing 500. In embodiments, although a specific configuration may be shown in the drawings and discussed in specification below, one or more components and/or assemblies or devices may be installed on a different surfaces and/or sides of an intelligence housing 500. Placement of components, assemblies and/or devices may depend on space availability on sides of an intelligence housing 500, interference considerations (e.g., noise interference and/or spectrum interference), heat considerations and/or power requirement considerations. In embodiments, a first side of an intelligence housing 500 may comprise one or more wind sensor assemblies 505 and one or more proximity sensors 530 being mounted or installed thereon. In embodiments, a second side of an intelligence housing 500 may comprise one or more microphone arrays 525 and/or one or more motor control assemblies or motor control printed circuit boards 510. In embodiments, a third side of an intelligence housing 500 may comprise a single board computer 520 (e.g., Raspberry Pi—or an integrated computing device) comprising one or more memory devices, one or more processors, and computer-readable/executable instructions stored in the one or more memory devices). In embodiments, a third side of an intelligence housing 500 may further comprise one or more wireless communication transceivers 535. In embodiments, one or more wireless communication transceivers 535 may be installed on a printed circuit board which is installed on a third surface (or alternatively may be integrated into a chip or integrated circuit which is installed on a third surface of intelligence housing 500). In embodiments, a fourth side of an intelligence housing 500 may comprise one or more microphone arrays 525. In embodiments, a fourth side of an intelligence housing 500 may comprise one or more imaging devices 515 to capture video of an area surrounding an umbrella, parasol or shading system. In embodiments, one or more imaging devices 515 may be integrated into a chip or integrated circuit or alternatively, may be mounted onto a printed circuit board. In embodiments, the different one or more microphone arrays 515 may need to be installed on opposite sides of an intelligence housing 500 in order to have close to 360 degree coverage for picking up sounds and/or voice commands from a user and/or operator. FIG. 5C illustrates a cover 555 attached or connected to a side of an intelligence housing 500. In embodiments, cover 555 includes an opening for to allow for sound waves to reach one or more microphones or microphone arrays. FIG. 5C also illustrates another side 502 of an intelligence housing.

FIG. 5D illustrates a wind sensor assembly according to embodiments. In embodiments, an intelligence housing 500 may comprise a wind sensor assemblies 505. In embodiments, one or more wind sensor assemblies 505 may comprise one or more fan assemblies 506, one or more wind channels 507, one or more vents or screens 508 and/or one or more wind speed sensors 509. In embodiments, one or more vents or screens 508 may be placed over an opening on an intelligence housing 500. In embodiments, an opening may comprise a top portion of one or more wind channels 507. In embodiments, one or more covers, vents and/or screens 505 may prevent small or large objects from entering a wind channel 507 and damaging a wind sensor 509. In embodiments, wind entering wind channel may cause one or more fan assemblies 506 to turn or rotate in proportion to a wind speed. In embodiments, one or more fan assemblies 506 may be connected or coupled to one or more wind sensors 509. In embodiments, one or more wind sensors 509 may generate wind speed measurements in proportion (or based at least in part) on fan assembly 506 rotation or turning speed. In embodiments, one or more wind speed sensors 509 may be Hall or Hall-effect sensors. In embodiments, one or more wind sensors 509 may be coupled or connected to one or more processors or controllers. In embodiments, one or wind sensors 509 may communicate generated wind speed measurements to one or more processors or controllers (including but not limited to a processor or controller in a parasol, umbrella or shading system integrated computing device).

Umbrellas, parasols, shading systems, lighting systems and voice-activated hubs (all of which may be referred to as shading devices) may utilize arms, blades and/or a frame along with shading fabric to provide to cover individuals standing beneath or in an area covered by the shading device. Prior art systems utilized threaded nuts and a collared frame extension or expansion assembly to expand or retract arms or blades and/or frames to open and/or closed positions. However, such prior art systems take up a lot of space and have a number of linkage assemblies that may lead to pieces malfunctioning or being broken more easily.

In embodiments, the present patent application comprises a novel or new arm expansion assembly. In embodiments, the arm expansion assembly may be utilized with existing umbrellas and/or parasols by replacing existing arm expansion assemblies and/or frames. For example the expansion assembly may replace the arm extension assemblies and/or arm support assemblies illustrated in FIGS. 1A-1C expansion or extension assembly. In embodiments, a shading device could include an arm expansion assembly coupled to a motor and/or motor controller. In embodiments, a manual knob or cranking device may manually operate the new arm expansion assembly. In other words, it may be manually operated or automatically operated. In embodiments, a shading device may comprise an azimuth motor assembly for rotating a shading system about a base assembly, an elevation assembly for rotating an upper part of a support assembly with respect to a lower part of a support assembly, and the new or novel arm expansion assembly, described herein for expanding and/or retracting arms and/or a frame (and the associated shading fabric). In embodiments, the new arm expansion assembly may also be part of a shading system for a lighting assembly and/or a voice-activated hub.

However, the shading device does not necessarily need rotate (e.g., have an azimuth motor) about a base or have an elevation rotation. In other words, the shading device may include many of the features described above in FIGS. 1-5, but may only have the unique arm expansion assembly to open and/or close the arms and/or frame of the shading device. Alternatively, the shading device may have one of the azimuth rotation assembly or the elevation rotation assembly and also have the unique arm expansion assembly.

The new arm expansion assembly has a lighter weight than prior art expansion assemblies due to the use of 3D printed materials for many components, assemblies, or structures in the new or unique arm expansion assembly. For example, the housings that comprise the arm supports, arm extension housings, as well as speaker and audio components may be made utilizing additive manufacturing techniques. In embodiments, the additive manufacturing techniques may utilize plastics, composites or metals, or a metal combination thereof. This may allow personalized or unique formations and allow easy interchangeability to different shapes because there are no molds necessary. The new arm expansion assembly also hides many mechanical assemblies or components from view, which is not only pleasing aesthetically but also is safer than prior art expansion assemblies since gearing assemblies and/or hinging assemblies are not in view and thus are not accessible to be touched or to catch articles of clothing or hair. In embodiments, in addition, a new arm expansion assembly may be modular and may be easily attached or detached to an existing linear actuator and/or a linear actuator housing or tubing. In addition, the new arm expansion assembly also allows the ability to attach or detach different types of arms or blades to adjust to different user requirements or different shading protection needs (e.g., the length of the arms, blades or frames may be shortened and/or lengthened). In embodiments, the shapes of the arms or blades may also be changed easily. In addition, because the arm supports are detachable from arm expansion housings (e.g., by unscrewing connectors), the arms supports may also change shape, have different section shapes, have different thicknesses, have different widths, thicknesses or lengths, or different angles with respect to the different sections. In addition, because the arm expansion assemblies are also detachable from one another, this allows for easier replacement of arm expansion gear assemblies as well as replacement of the expansion gear itself. In addition, by removing the arm expansion assemblies, access to the rack gear may be obtained in order to replace the rack gear assembly). Further, the footprint of (and/or space taken up by) the umbrella with the arm expansion assembly and/or speaker and amplifier housing) is significantly reduced due to the use of the linear actuator which is housed in tube that runs through a center of the speaker and amplifier housing) as well as having the arm support assemblies rest against an outer surface of the speaker and/or amplifier housing.

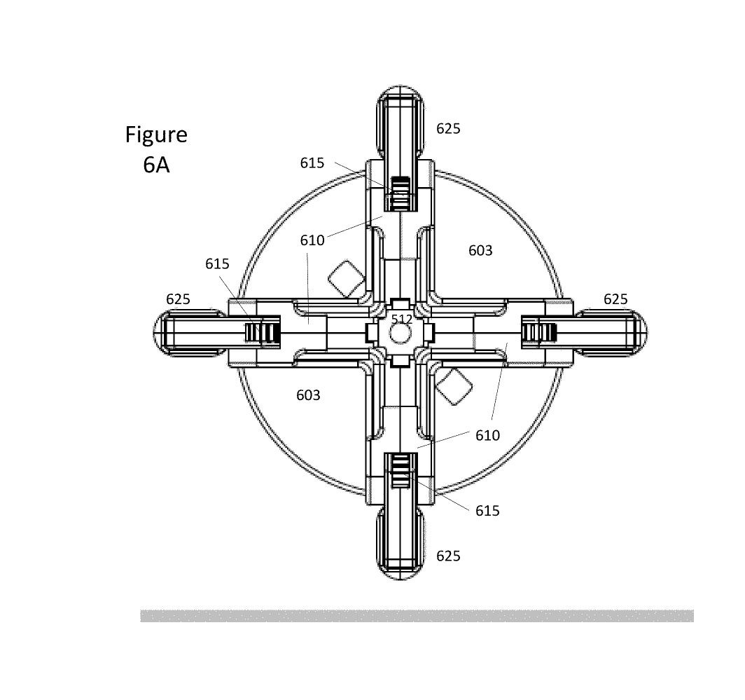

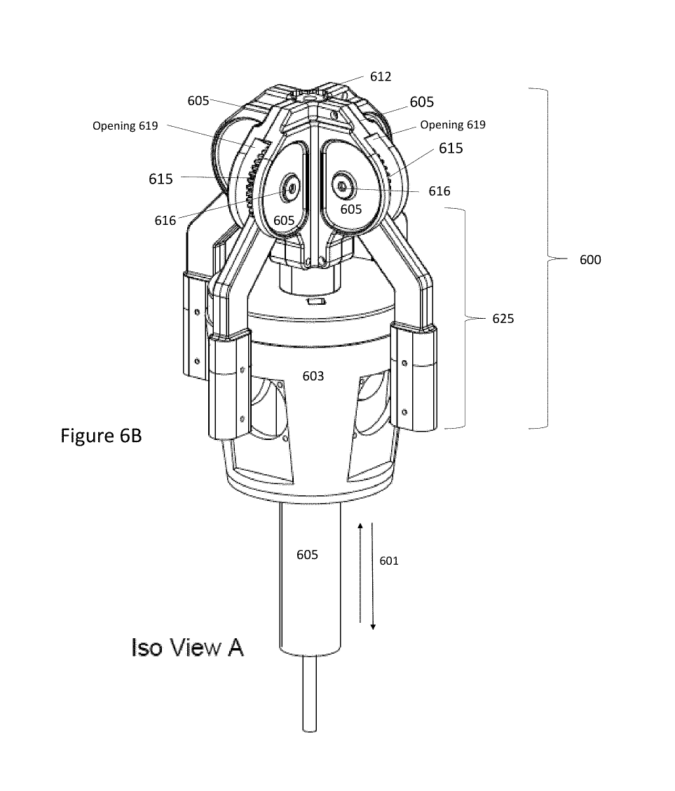

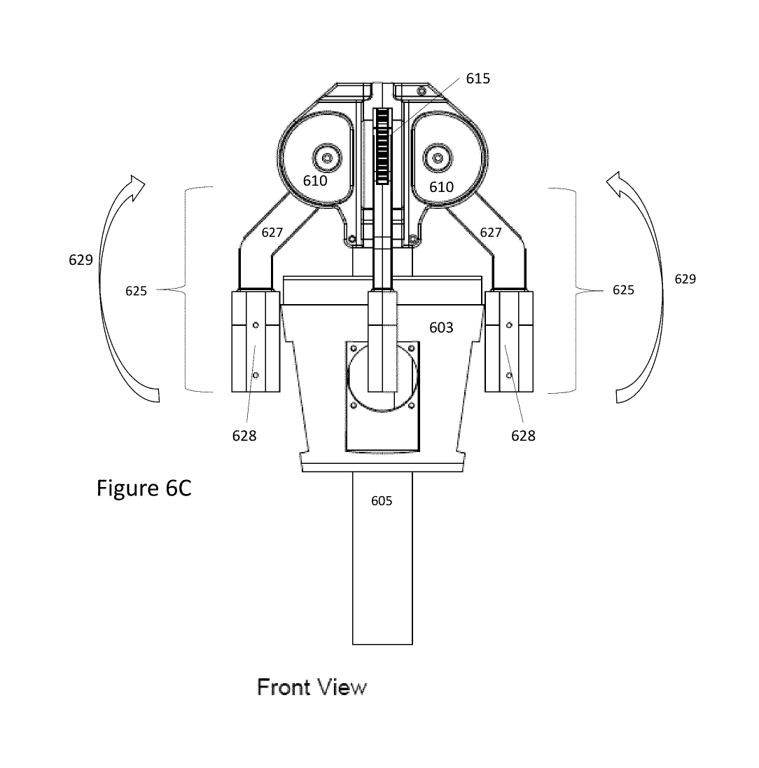

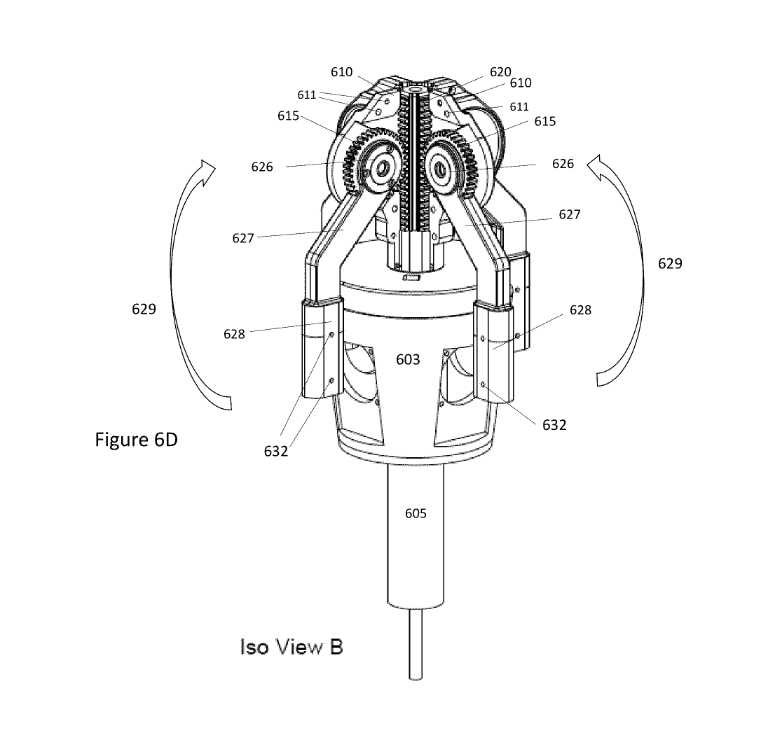

FIG. 6A illustrates a top view of an arm expansion assembly according to embodiments. FIG. 6B illustrates a side isometric view of an arm expansion assembly according to embodiments. FIG. 6C illustrates a front view of an arm expansion assembly according to embodiments. FIG. 6D illustrates a side isometric view with gearing assembly covers removed according to embodiments. In embodiments, a shading device may comprise a speaker and/or amplifier housing 603, an actuator housing 605 and an arm expansion assembly 600 (which includes everything above the amplifier housing). In embodiments, an arm expansion assembly 600 comprises one or more arm extension or expansion gear housings 610, one or more arm expansion gears 615, at least one rack gear 620 and one or more arm supports 625.

In embodiments, an actuator housing 605 may comprise an aluminum housing or aluminum tube. In embodiments, an actuator housing 605 may comprise a linear actuator installed inside and/or connected or coupled to an interior surface. In embodiments, a linear actuator may be coupled or connected at one end (e.g., an upper end) to a rack gear or rack gear assembly 620. In embodiments, the terms rack gear or rack gear assembly may be utilized interchangeably. In embodiments, a linear actuator may be connected or coupled at a second end to a motor assembly. In embodiments, a linear actuator may move in a vertical direction up or down (as illustrated by arrow 601), which results in upwards or downward vertical movement of the rack gear 620. In embodiments, a rack gear 620 may be made of a metal material. In embodiments, a rack gear 620 may be made of a plastic material or a composite material, or combination thereof. In embodiments, a rack gear 620 may be manufactured via additive manufacturing techniques

In embodiments, as illustrated in FIGS. 6A-6D, an arm expansion assembly may comprise four expansion gear housings 610. In other embodiments, an arm expansion assembly may comprise two, three or more than four expansion gear housings 610. In embodiments, a number of expansion gear housings 610 may correspond to a number of arms in a shading device. In embodiments, the expansion gear housings 610 may each providing a housing and/or be coupled to an arm expansion gear 615. In embodiments, an expansion gear housing 610 may completely or partially encircle or enclose an associated arm expansion gear 615. In embodiments, the one or more expansion gear housings 610 may be connected or coupled to a top end of an actuator housing 605 (e.g., a top end of a metal tube). In embodiments, the one or more expansion gear housings 610 may be connected to the actuator housing 605 via one or more fasteners, screws and/or welds. In embodiments, the one or more expansion gear housings 610 may be made or manufactured utilizing a 3D printer (e.g., via additive manufacturing techniques). The 3D printer may utilize a plastic material, a composite material or a combination thereof to make or manufacture the one or more expansion gear housings 610.

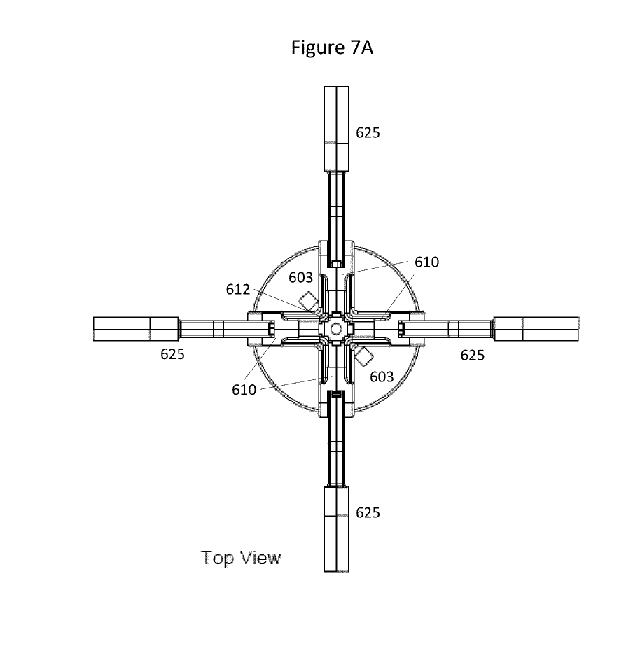

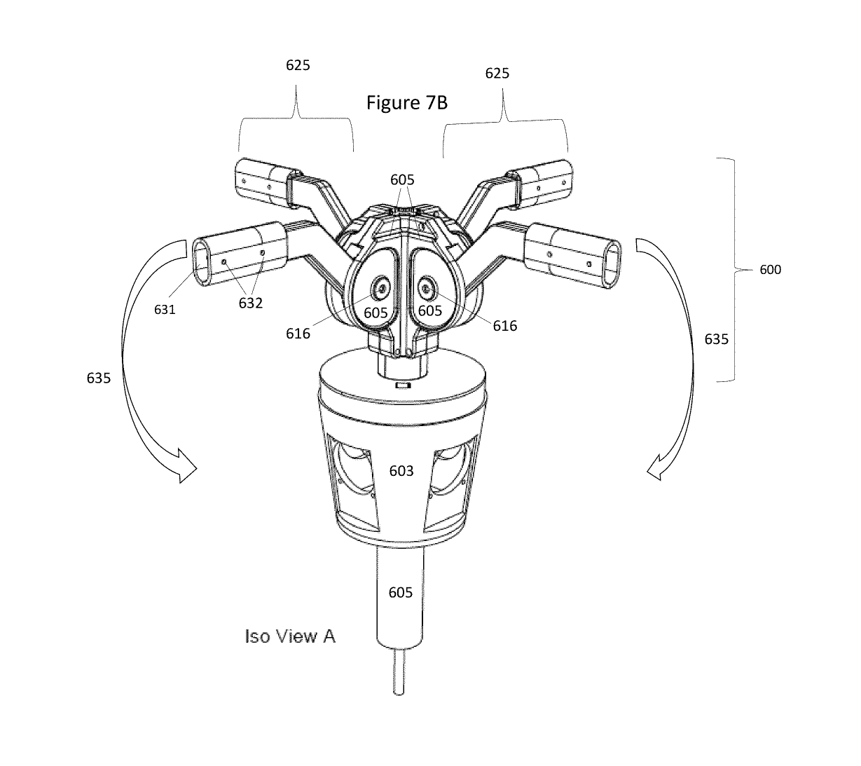

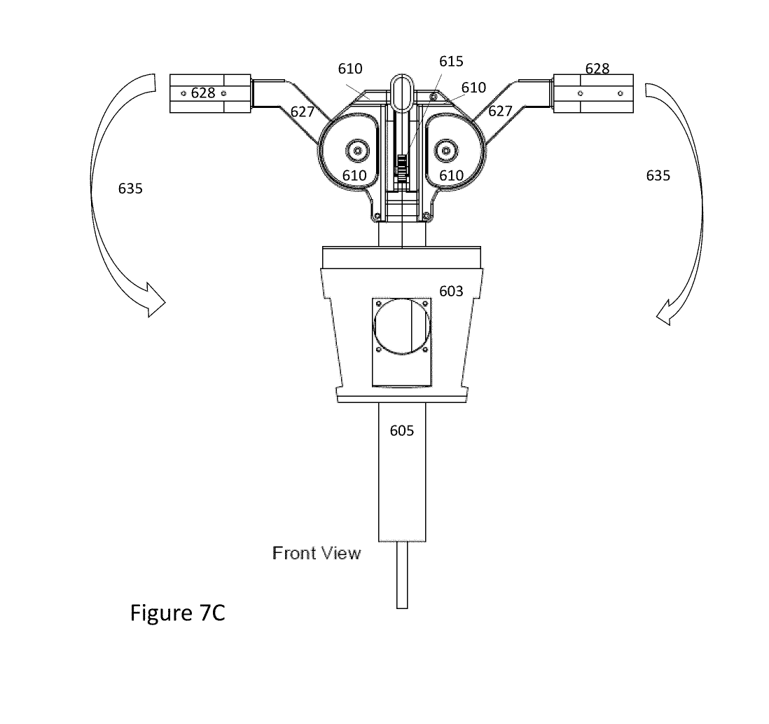

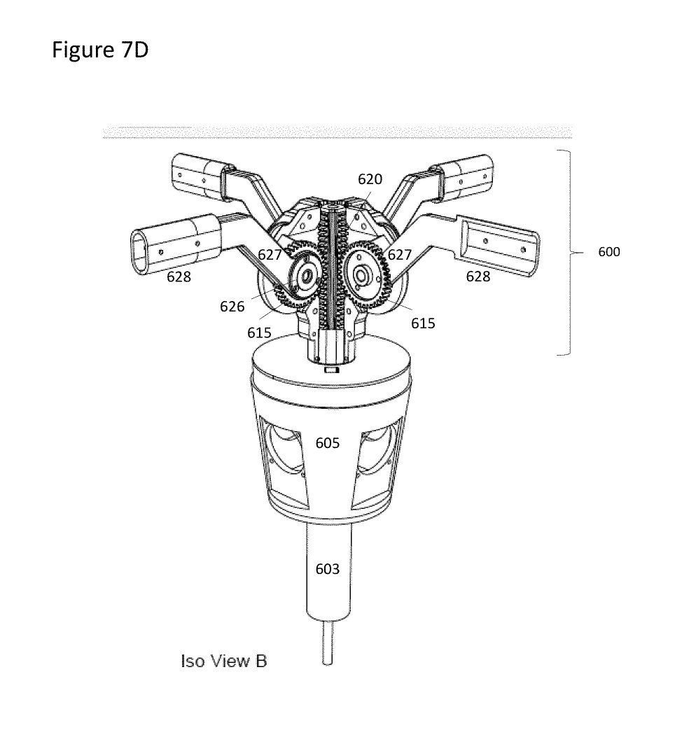

FIG. 6D illustrates an arm expansion assembly with one of the expansion gear housings 610 removed (leaving three extension gear housings). In embodiments, an expansion gear housing 610 may comprise two sides or sections, where the two sides or sections are placed at approximately 90 degrees with respect to each other. In embodiments, an angle at which the two sections of the expansion gear housings 610 are placed or positioned may be dependent on the number of expansion gear housings (and thus the number of arms). In embodiments, the angle may range between 70 to 110 degrees. In embodiments, the expansion gear housing 610 may comprise an opening 616 on each side to allow a connector to pass through and fasten the arm expansion gears 615 to the associated arm supports 625. In embodiments, the one or more expansion gear housings 610 may further include openings or recesses 611 to allow fasteners to connect adjacent gear housings assemblies 610. In embodiments, the one or more expansion gear housings 610 come together or meet at a top of an arm expansion assembly and there is an area 612 where a sensor module may be located or positioned. In embodiments, when adjacent one or more expansion gear housings 610 are connected, an opening 619 is formed, in which the one or more expansion gears 615 are positioned. The space or opening 619 is illustrated in FIGS. 6B and 7B. In embodiments, the space or opening 619 allows the expansion gears 615 to rotate and the arm support assemblies to rotate to either an opened and/or closed position. In embodiments, when the one or more expansion gear housings meet and/or positioned, a space is formed in the middle of the one or more expansion gearing housings 610. In embodiments, the space may be a circular space, a rectangular space and/or a square space. In embodiments, a rack gear 620 may be located in the space in a middle of the one or more expansion gear housings 610 (as illustrated in FIGS. 6D and 7D). In embodiments, a sensor module may be coupled or connected on top of a rack gear 620. In embodiments, a rack gear 620 may be located under a sensor module 612.

In embodiments, one or more arm supports 625 may be coupled or connected to associated one or more arm expansion gears 615. In embodiments, when one or more extension gear housings 610 are coupled or connected to each other, an opening may be formed (e.g., opening 619). In embodiments, the one or more arm supports 625 may be inserted and/or positioned into the opening 619. In embodiments, fasteners may be inserted through openings 616 in the associating extension gear housings 610, the associated arm expansion gears 615 and the arm supports or arm support assemblies 625. In embodiments, as illustrated in FIGS. 6A to 6D, the one or more arm supports or arm support assemblies 625 may comprise of a circular section 626 (where the one or more arm supports 625 connect to the associated arm expansion gears 615), a second section 627, and a third section 628, where the third section 628 is positioned at an angle with respect to the second section 627. In embodiments, the third section 628 may be positioned at an angle with respect to the second section 627 in order to take up less space when the shading system is in a closed position or a retracted state, as is illustrated in FIGS. 6A-6D. In such an illustrative embodiments, a majority of the third section 628 of the one or more arm supports 625 may rest against an outside surface of a speaker and/or amplifier housing 603.

FIG. 7A illustrates a top view of an arm expansion assembly in an open or deployed position according to embodiments. FIG. 7B illustrates a side isometric view of an arm expansion assembly in an open or deployed position according to embodiments. FIG. 7C illustrates a front view of an arm expansion assembly in an open or deployed position according to embodiments. FIG. 7D illustrates a side isometric view with gearing assembly covers removed of an arm expansion assembly in an arm expansion assembly according to embodiments. In embodiments, the third section 628 of the one or more arm supports 625 may be positioned at an angle with respect to the second section 627 so that when the arm support (and attached arms) 625 are in a fully opened or deployed position, the third section 628 of the arms supports or arm support assemblies 625 (and the attached arms) are positioned at approximately a 90 degree angle with respect the ground and the actuator housing (and thus central support tube) (as is illustrated in FIGS. 7A-7D). The rotation of the one or more arm supports 625 is illustrated by the arrow and reference number 629 in FIGS. 6C-6D. In embodiments, the rotation of the one or more arm supports 625 is illustrated by arrow and reference number 635 in FIGS. 7B and 7C. In embodiments, reference number 629 illustrates an opening movement of the one or more arm supports 625 according to embodiments. In embodiments, the circular section 626, the second section 627 and the third section 628 may be a unitary piece, which is formed during additive manufacturing. In embodiments, as is illustrated in FIGS. 6A to 6D and FIGS. 7A to 7D, thicknesses and widths of the circular section 626, the second section 627 and the third section 628 may be different. In embodiments, one end of a third section 628 of the one or more arm supports 625 is open. In embodiments, at least a portion of the third section 628 of the one or more arm supports 625 is hollow. In embodiments, one or more arms are placed into the hollow opening or recess 631 of the one or more arm supports 625. In embodiments, the third sections 628 of the one or more arm supports include openings 632 to allow arms and/or blades to be connected and/or inserted into the one or more openings 632. This allows the one or more arms to be changed in order in case of malfunction, broken parts or an arm length needs to be changed.

In embodiments, a motor assembly may receive commands from one or more processors in a shading device. In embodiments, a motor controller in a motor assembly may communicate commands or signals to a motor to rotate. In embodiments, a rotation of a motor may cause a linear actuator to move in a downward vertical direction. In embodiments, movement of a linear actuator may cause movement and/or rotation of a rack gear 620 in a downward direction, as illustrated by reference number. In embodiments, the movement and/or rotation of a rack gear 620 in a downward vertical direction engages the one or more arm expansion gears and causes the one or more arm expansion gears 615 to rotate. In embodiments, the engagement and/or rotation of the one or more arm expansion gears 615 causes the coupled one or more arm supports 625 to rotate and/or lift from a resting or closed position and move to a deployed or open position (as is illustrated in FIGS. 7A-7D). In embodiments, the rotation of a motor may cause a linear actuator to move in an upward vertical direction, which may cause the rack gear to move in an upwards vertical direction. In embodiments, movement of the rack gear in an upward vertical direction may cause the one or more arm extension gears to rotate, which may cause the one or more arm supports 625 to rotate and/or lift from a closed position to an open position. Similarly, the movement and rotation of the rack gear 620 may cause arms supports 625 to move from an open position to a closed position and/or resting position (after receiving commands, instructions, signals or messages from one or more processors) by causing the assemblies described above to operate in the opposite fashion and/or direction.

In embodiments, an integrated computing device may store and/or execute shading object or umbrella application software, which may be referred to as SMARTSHADE and/or SHADECRAFT application software. In embodiments, shading object or umbrella application software may be run and/or executed on a variety of computing devices including a computing device integrated within a shading object or umbrella. In embodiments, for example, shading object or modular umbrella application software may include computer-readable instructions being stored in non-volatile memories of a computing device, a portable electronic device (e.g., a smart phone and/or a tablet), an application server, and/or a web application server, all which interact and communicate with each other. In embodiments, computer-readable instructions may be retrieved from memories (e.g., non-volatile memories) of these above-identified computing devices, loaded into volatile memories and executed by processors in the computing device, portable electronic device, application server, and/or mobile application server. In embodiments, a user interface (and/or graphical user interface) for a modular umbrella software application may be presented on a portable electronic device, although other computing devices could also execute instructions and present a graphical user interface (e.g., dashboard) to an individual. In embodiments, modular umbrella application software may generate and/or display a dashboard with different application (e.g., process) selections (e.g., weather, health, storage, energy, security processes and/or application processes). In embodiments, modular umbrella application software may control operation of a modular umbrella, communicate with and receive communications from modular umbrella assemblies and/or components, analyze information obtained by assemblies and/or components of a modular umbrella, integrate with existing home and/or commercial software systems, and/or store personal data generated by the modular umbrella, and communicate with external devices.

In embodiments, a portable electronic device may also comprise a mobile application stored in a non-volatile memory. In embodiments, a mobile application may be referred to as a SHADECRAFT or a SMARTSHADE mobile application. In embodiments, a mobile application (mobile app) may comprise instructions stored in a non-volatile memory of a portable electronic device, which can be executed by a processor of a portable electronic device to perform specific functionality. In embodiments, this functionality may be controlling of, interacting with, and/or communicating with a shading object. In embodiments, mobile apps may provide users with similar services to those accessed and may be individual software units with limited or specific function. In embodiments, applications may be available for download from mobile application stores, such as Apple's App Store. In embodiments, mobile apps may be known as an app, a Web app, an online app, an iPhone app or a smartphone app. In embodiments, a sensor device (or other IoT device) may communicate to a server computing device via a cellular communications network, a wireless communication network, a wired communication network and/or other communication network. In embodiments, a sensor device and/or assembly device may capture sensor measurements, data and/or conditions and may communicate sensor measurements, data and/or conditions to an IoT enabled server, which may analyze, store, route, process and/or communicate such sensor measurements, data and/or conditions. In embodiments, an Internet of Things (IoT) may be a network of physical objects—sensors, devices, vehicles, buildings, and other electronic devices. In embodiments, the IoT may sense and/or control objects across existing wireless communication network infrastructure, an existing cellular communication network, and/or a global communications network infrastructure. In embodiments, integrating of devices via IoT may create opportunities for more direct integration of a physical world into computer-based systems, which may result in improved efficiency, accuracy and economic benefit. In addition, when an IoT device or server is augmented with sensors and actuators, IoT may be integrated or enabled with a more general class of cyber-physical systems, e.g., smart grids, smart homes, intelligent transportation and smart cities. In embodiments, in IoT, for example, may be uniquely identifiable through its embedded computing system but is able to interoperate within the existing Internet infrastructure. In embodiments, a device may have a specific IP address in order to be addressed by other IoT enabled systems and/or devices. In embodiments, an IP address may be provided and/or established by routers and/or Internet service providers. For example, a modular umbrella enabled with IoT capability, because it may incorporate cameras, may be able to communicate with or be integrated into a home or office security system. Further, if an individual has a smart home, an individual may be able to control operation of, or communicate with a modular umbrella shading system as part of an existing smart home software application (either via a smart phone, mobile communication device, tablet, and/or computer). In addition, a modular umbrella shading system, if part of IoT, may be able to interface with, communicate with and interact with an existing home security system. Likewise, a modular umbrella shading system may be able to be an additional sound reproduction device (e.g., via speaker(s)) for a home audio and/or video system that is also on the IoT. In addition, a modular umbrella system may be able to integrate itself with an electronic calendar (stored on a computing device) and become part of a notification or alarm system because it will identify when upcoming meetings are occurring.

In embodiments, a modular umbrella system may be a device on an Internet of Things (IoT). In embodiments, an IoT-enabled device may be one or more cameras, one or more environmental sensors, one or more directional sensors, one or more movement sensors, one or more motor assemblies, one or more lighting assemblies and/or one or more solar panels or cells. These objects and/or IoT-enabled devices may comprise items and/or device may be embedded with electronics, software, sensors, and network connectivity, which enables these physical objects to detect, collect, process and/or exchange data with each other and/or with computing devices, Shadecraft IoT-enabled servers, and/or third-party IoT enabled servers connected to a modular umbrella system via a global communications network (e.g., an Internet).

In embodiments, IoT devices (e.g., servers, sensors, appliances, motor assemblies, outdoor shading systems, cameras, lighting assemblies, microphones, computing devices, etc.) may communicate with each other utilizing an Internet Protocol Suite. In embodiments, IoT devices may be assigned an IP address and may utilize IPv6 communication protocol. In embodiments where security is important, authentication may be established utilizing OAUTH (e.g., version 2.0) and Open ID Connect protocols (e.g., version 1.0). In addition, in embodiments, the IEEE 802.15.4 radio standard may allow for reduction in power consumption by IoT devices utilizing RF communications. In embodiments where power consumption may need to be decreased, e.g., as in sensors, modular umbrella shading systems, shading systems, cameras, processors), communication with IoT devices may utilize Message Queuing Telemetry Transport (MQTT) which utilizes TCP for its transport layer and utilizes a central MQTT broker to manage and/or route messages among a MQTT network's nodes. In embodiments, communication with IoT devices may utilize Constrained Application Protocol (CoAP) which utilizes UDP as its transport protocol. In embodiments, CoAP may be a client/server protocol and allows a one-to-one report/request instruction model. In embodiments, CoAP also may have accommodations for multi-cast transmission of messages (e.g., one-to-many report/request instruction model).

Non-volatile storage medium/media is a computer readable storage medium(s) that can be used to store software and data, e.g., an operating system, system programs, device drivers, and one or more application programs, in a computing device or one or more memory devices of a balcony shading and power system processor, controller and/or computing device. Persistent storage medium/media also be used to store device drivers, (such as one or more of a digital camera driver, motor drivers, speaker drivers, scanner driver, or other hardware device drivers), web pages, content files, metadata, playlists, data captured from one or more assemblies or components (e.g., sensors, cameras, motor assemblies, microphones, audio and/or video reproduction systems) and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in a balcony shading and power system controller may include or may execute a variety of possible applications, such as a software applications enabling communication with other devices, such as communicating one or more messages such as via email, short message service (SMS), or multimedia message service (MMS), FTP, or other file sharing programs, including via a network, such as a social network, including, for example, Facebook, LinkedIn, Twitter, Flickr, or Google+ and/or Instagram provide only a few possible examples. A computing device or a processor or controller in a balcony shading and power system may also include or execute an application to communicate content, such as, for example, textual content, multimedia content, or the like. A computing device or a processor or controller in a balcony shading and power system may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a balcony shading and power system and/or mobile computing device may also include imaging software applications for capturing, processing, modifying and transmitting image, video and/or sound files utilizing the optical device (e.g., camera, scanner, optical reader) within a mobile computing device and/or a balcony shading and power system.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, DRAM, DDRAM, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. An umbrella arm expansion assembly, comprising:
one or more arm expansion gear housings;
an actuator housing including a linear actuator;
one or more rack gear assemblies; and
one or more arm support assemblies,
wherein the one or more rack gear assemblies move in a vertical direction in response to vertical movement of the linear actuator.

2. The umbrella arm expansion assembly of claim 1, wherein the one or more rack gear assemblies are made utilizing additive manufacturing techniques.

3. The umbrella arm expansion assembly of claim 1, wherein the one or more rack gear assemblies consists of a plastic material.

4. The umbrella arm expansion assembly of claim 1, wherein the one or more expansion gear housings are coupled to a top of the actuator housing.

5. The umbrella arm expansion assembly of claim 1, wherein the one or more expansion gear housings are made utilizing additive manufacturing techniques.

6. The umbrella arm expansion assembly of claim 1, wherein the one or more expansion gear housings each comprise two sections.

7. The umbrella arm expansion assembly of claim 6, wherein a first section of the two sections of the expansion gear housings is positioned approximately 90 degrees with respect to a second section.

8. The umbrella arm expansion assembly of claim 1, wherein a first expansion gear housing of the one or more expansion gear housings is connected to an adjacent second expansion gear housing and an opening is formed between the first expansion gear housing and the second expansion gear housing.

9. The umbrella arm expansion assembly of claim 8, further comprising an expansion gear and one or more connectors, wherein the one or more connectors are passed through a hole in the first expansion gear assembly, the expansion gear and the second expansion gear assembly to connect the expansion gear, wherein the expansion gear is positioned in the formed opening.

10. The umbrella arm expansion assembly of claim 9, wherein the expansion gear is engaged with the one or more rack gear assemblies and the expansion gear rotates in a clockwise or counterclockwise direction in response to vertical movement of the one or more rack gear assemblies.

11. The umbrella arm expansion assembly of claim 10, wherein a first arm support section and a second arm support section of the one or more arm support assemblies are attached to the expansion gear, wherein the first arm support section and the second arm support section rotate in a clockwise or counterclockwise direction in response to the rotation of the expansion gear.

12. The umbrella arm expansion assembly of claim 11, wherein one or more arms or blades of the umbrella are connected or coupled to the one or more arm support assemblies, wherein the one or more arm or blades expand or retract in response to the rotation of the first arm support section and the second arm support section.

13. The umbrella arm expansion assembly of claim 12, wherein the one or more expansion gear assemblies are four expansion gear assemblies.

14. The umbrella arm expansion assembly of claim 13, wherein a circular area is formed by top surfaces of the four expansion gear assemblies.

15. The umbrella arm expansion assembly of claim 14, wherein a sensor module is coupled to the circular area and captures sensors measurements for the umbrella.

16. The umbrella arm expansion assembly of claim 1, further comprising a speaker housing, the speaker housing comprising a center opening.

17. The umbrella arm expansion assembly of claim 16, wherein the actuator housing is positioned in the center opening and the speaker housing surrounds the actuator housing.

18. The umbrella arm expansion assembly of claim 16, wherein the one or more arm support assemblies rest adjacent to an outside surface of the speaker housing.
